(19) United States
(12) Patent Application Publication
(10) Pub. No.: US 2010/0121022 A1
(43) Pub. Date: May 13, 2010

(54) 1,3-DIPOLAR CYCLOADDITION OF AZIDES TO ALKYNES

(76) Inventors: Osama M. Musa, Hillsborough, NJ (US); Laxmisha M. Sridhar, Monmouth Junction, NJ (US); Qingwen Wendy Yuan-Huffman, Belle Mead, NJ (US)

Correspondence Address: Henkel Corporation, 10 Finderne Avenue, Bridgewater, NJ, 08807, US

(21) Appl. No.: 12/445,165

(22) PCT Filed: Jul. 26, 2007
(86) PCT No.: PCT/US2007/074449

§ 371 Date: Jan. 12, 2010

Related U.S. Application Data
(60) Provisional application No. 60/852,177, filed on Oct. 17, 2006.

(51) Int. Cl. C08G 73/00; C08G 73/06; C08G 65/02; C08G 73/10

(52) U.S. Cl. 528/319; 528/423; 528/410; 528/363

(57) ABSTRACT

A process for the bulk polymerization, in the absence of any solvent, of a reactant containing azide functionality and a reactant containing a terminal alkyne functionality, in the presence of Cu (I) catalyst or in the presence of a Cu(II) catalyst without a reducing agent, is described. Polymerization can be achieved at temperatures less than 100° C., which is suitable for low temperature cures. A controlled synthesis for low molecular weight oligomers is disclosed.

### BACKGROUND OF THE INVENTION

This invention relates to a process for the bulk polymerization of azide and alkyne monomers using a 1,3-dipolar cycloaddition reaction. This process is hereinafter referred to as azide/alkyne chemistry.

Sharpless and co-workers from Scripps Research Institute, in US patent application 2005/0222427 and in EP patent 1507769, described a copper (I)-catalyzed ligation process of azides and alkynes in solution phase using Cu(II) salts in the presence of a reducing agent, such as sodium ascorbate, which furnished triazole polymers under ambient conditions. See also, H. C. Kolb, M. G. Finn and K. B. Sharpless, Angew. Chem. Int. Ed. 2001, 40, 2004-2021. The authors cited the advantage of the catalyzed process, in contrast to the uncatalyzed process, as being a dramatic acceleration of rate and exclusive 1,4-regioselectivity. The same authors have also described the use of this azide/alkyne ligation chemistry for the preparation of triazole polymers as metal adhesives using Cu(I) catalysts, prepared by reducing Cu (II) or by oxidizing copper metal to Cu (I) in situ, in D. D. Diaz, S. Punna, P. Holzer, A. K. Mcpherson, K. B. Sharpless, V. V. Fokin, M. G. Finn, J. Polym. Sci: Part A: Polym. Chem. 2004, 42, 4392-4403.

The azide/alkyne chemistry requires relatively mild reaction conditions that are insensitive to air and moisture. This is in contrast to the conditions used in radical polymerizations that often are inhibited by oxygen, leading to incomplete polymerization and reduced yield. Nevertheless, the reactions are conducted in solution phase, either water or solvent, requiring the disposal or recycling of the water or solvent, adding time and steps to the synthetic process, and it would be a benefit to have a process that did not entail recycling of solvent.

The temperature used to initiate and maintain the polymerization will be usually within the range of 50° C. to 200° C. Although these are relatively low temperatures, it would be a benefit in certain applications to be able to further lower the cure temperature, especially when low temperature and fast cure are more economical in fabrication processes.

### SUMMARY OF THE INVENTION

This invention is a process for the synthesis of a product having a triazole functionality comprising the bulk polymerization of a first reactant having an azide functionality and a second reactant having a terminal alkyne functionality, using a copper (I) catalyst, or a copper (II) catalyst without a reducing agent, in the absence of any solvent, and includes the products from these processes. “In the absence of any solvent” means that a solvent is not used for the reaction medium. Although compounds that could be deemed solvents may be present, they are not present in such quantity as to behave as a medium for the reaction, and, in essence, the reaction is a bulk phase polymerization as that term is understood in the art.

In another embodiment, a preliminary step is added to the process, which comprises the reaction of the azide and the alkyne under conditions to give an oligomer. The oligomer is then used as a compatibilizer for the azide and alkyne in the main polymerization reaction. The oligomer also acts as a toughening agent for the azide/alkyne polymerized product, and this product is a further embodiment of the invention.

In one embodiment the process and products further include the presence of metal particles or flakes. The addition of the metal particles or flakes during the reaction process, the particles or flakes typically added as conductive filler, has the unexpected effect of lowering the reaction temperature of the azide and alkyne reactants.

In an additional embodiment, at least one other reactive compound, such as a free-radical or an ionic curing compound, is added to the reaction mix of azide and alkyne. Thus, the invention in this embodiment is the process including the presence of the additional reactant and the products from this process.

In another embodiment, this invention is a two-part adhesive composition in which the first part is a reactant containing an azide functionality and the second part is a reactant containing an alkyne functionality, in which either the first part or the second part, or both, contain the Cu(I) or Cu(II) catalyst. The first and second parts are held separately and mixed just before dispensing. Mechanical means are the preferred means for mixing.

### BRIEF DESCRIPTION OF THE FIGURES

FIG. 1 is a graph of the DSC (differential scanning calorimetry) peak temperature as a function of loading level of silver filler in dimer azide, bisphenol-A propargyl ether and 1% CuSBu.

FIG. 2 is a graph of the DSC peak temperature as a function of loading level of silver flake in dimer azide and bisphenol-A propargyl ether with no Cu catalyst.

FIG. 3 is the DSC of Example 37a;

FIG. 4 is the DSC of Example 37b;

FIG. 5 is the DSC of Example 37c;

FIG. 6 is the DSC of Example 37d;

FIG. 7 is the DSC of Example 37e.

AZIDE/ALKYNE BULK PHASE POLYMERIZATION. The bulk phase polymerization for the azide/alkyne chemistry occurs between a first reactant having an azide functionality and a second reactant having a terminal alkyne functionality using copper(I) or copper (II) initiators in the absence of any solvent. Reducing agents can be used to bring copper (II) to copper (I) as described in the Sharpless procedure, but in the bulk phase the polymerization occurs with or without the presence of any reducing agent when only copper (II) is present. If the practitioner chooses to use a reducing agent, it can be an independent molecule, or the reducing functionality can be part of either the alkyne or the azide molecule.

The copper catalysts used in this invention may have halogen, oxygen, sulfur, phosphorous, or nitrogen ligands or a combination of these. In general, the amount of the Cu(I) or Cu(II) catalyst will range from 0.01% to 5% by weight of the alkyne and azide containing compounds.

The reactants containing azide functionality used in the inventive process can be monomeric, oligomeric, or polymeric, and can be aliphatic or aromatic, with or without heteroatoms (such as, oxygen, nitrogen and sulfur). The reactants containing alkyne functionality can be aliphatic or aromatic.

AZIDE/ALKYNE BULK PHASE POLYMERIZATION USING CU(II) CATALYST WITHOUT REDUCING AGENT. Prior art teaches that the azide/alkyne chemistry is catalyzed by a copper (I) catalyst or a copper (II) catalyst in combination with a reducing agent. The inventors have observed significant reduction of DSC peak temperature by using a copper(II) catalyst without a reducing agent, even in those cases in which the copper (II) catalyst was not soluble in the resin system. Example 3 sets out the data showing that copper (II) adipate catalyzed the reaction of dimer azide and bisphenol-E propargyl giving much narrower DSC peaks (smaller ΔT) than that of the control and than those of the Cu(I) catalysts.

USE OF AZIDE OR ALKYNE TO FORM OLIGOMERS PRELIMINARY TO POLYMERIZATION. In one embodiment, the bulk polymerization process as described above comprises the preliminary step of reacting the azide and alkyne to give an oligomer containing either unreacted azide functionality or unreacted alkyne functionality, or both, depending on which reactant was used in excess or depending on the reaction conditions. This preliminary reaction (sometimes referred to as “heat staging”) can be controlled by the amount of reactants added or by the length of reaction time to yield a molecular weight ranging from 200-10,000 Daltons. One skilled in the art has the expertise to prepare such oligomers. The oligomerization may be performed using azides and alkynes in the same or different mole ratios, in bulk or in a solvent, with or without catalyst. The resultant intermediate is an oligomer that then can be used in a secondary polymerization event utilizing the azide/alkyne chemistry as described in this specification.

The oligomer serves as a compatibilizer for the reactant azides and alkynes (that is, as an agent to improve the miscibility of the azides and alkynes) and as a toughening agent for the reactant azides and alkynes (that is, as an agent to improve fracture toughness by reducing the cross-link density and introducing polymeric lengths). The oligomerization may be performed using azides and alkynes in the same or different mole ratios with or without catalyst. It may also be used in a solvent process in addition to the bulk polymerization.

In this embodiment, the process comprises (a) reacting a first reactant having an azide functionality and a second reactant having a terminal alkyne functionality, using a copper (I) catalyst, or a copper (II) catalyst without a reducing agent, in the absence of any solvent to form an oligomer; (b) reacting the oligomer with a reactant having an azide functionality or a reactant having a terminal alkyne functionality, or both, using a copper (I) catalyst, or a copper (II) catalyst without a reducing agent. The products from this process are one embodiment of this invention and exhibit thermoplastic behavior from the added molecular chain length of the of azide/alkyne oligomer.

AZIDE/ALKYNE POLYMERIZATION IN THE PRESENCE OF CU CATALYST AND METAL FILLER. When the azide and alkyne compounds are formulated with both a copper catalyst and an elemental metal, the curing temperature is reduced further than when just the copper catalyst is used. The degree of DSC peak temperature reduction depends on the amount of copper catalyst present, as well as on the amount of metal filler. When the amount of copper catalyst is increased, the curing temperature of the azide/alkyne reaction is reduced. However, when metal particles or flakes are added to the azide/alkyne chemistry in the presence of the copper catalyst, and the level of copper catalyst is kept constant, the curing temperature is even further reduced. Metal filler alone, in the absence of the copper catalyst, did not reduce the reaction temperature, indicating that the effect between the copper catalyst and filler is synergistic.

The preferred metal is Ag flakes or particles. In one embodiment of azide/alkyne/Cu(I) compositions, this synergistic catalytic effect was observed in DSC scans showing considerably lower peak temperatures when Ag flakes were added into the composition, making this system suitable for quick, low temperature cure applications.

AZIDE/ALKYNE CHEMISTRY WITH ADDITIONAL REACTIVE COMPOUNDS. In one embodiment, an additional reactant, such as a thermosetting or thermoplastic compound or polymer, is added to the azide/alkyne chemistry mix. The catalyst for this reaction will be either a copper (I) catalyst, or a copper (II) catalyst without a reducing agent. The copper is capable of catalyzing both the azide/alkyne chemistry and the radical or ionic polymerization of the additional reactant; optionally, a radical curing agent or an ionic curing agent may be added to the polymerization mix. The polymerizations of the azide/alkyne chemistry and of the additional reactive compound, can occur simultaneously or sequentially, depending on whether one or more than one catalyst is used. If one catalyst is used, the polymerizations will occur simultaneously. If a radical initiator or an ionic initiator is used in addition to the copper catalyst, and the temperature at which the radical catalyst or ionic catalyst is activated is different from the temperature at which the copper catalyst is activated, the polymerizations will occur sequentially. In this specification and the claims, catalyst and initiator are used interchangeably.

Suitable reactants are selected from the group consisting of epoxy, maleimide (including bismaleimide), acrylates and methacrylates, and cyanate esters, vinyl ethers, thiol-enes, compounds that contain carbon to carbon double bonds attached to an aromatic ring and conjugated with the unsaturation in the aromatic ring (such as compounds derived from cinnamyl and styrenic starting compounds), fumarates and maleates. Other exemplary compounds include polyamides, phenoxy compounds, benzoxazines, polybenzoxazines, polyether sulfones, polyimides, siliconized olefins, polyolefins, polyesters, polystyrenes, polycarbonates, polypropylenes, poly(vinyl chloride)s, polyisobutylenes, polyacrylonitriles, poly(vinyl acetate)s, poly(2-vinylpyridine)s, cis-1,4-polyisoprenes, 3,4-polychloroprenes, vinyl copolymers, poly(ethylene oxide)s, poly(ethylene glycol)s, polyformaldehydes, polyacetaldehydes, poly(b-propiolacetone)s, poly(10-decanoate)s, poly(ethylene terephthalate)s, polycaprolactams, poly (11-undecanoamide)s, poly(m-phenylene-terephthalamide)s, poly(tetramethylene-m-benzenesulfonamide)s, polyester polyarylates, poly(phenylene oxide)s, poly(phenylene sulfide)s, poly(sulfone)s, polyetherketones, polyetherimides, fluorinated polyimides, polyimide siloxanes, poly-isoindolo-quinazolinediones, polythioetherimide poly-phenyl-quinoxalines, polyquinixalones, imide-aryl ether phenylquinoxaline copolymers, polyquinoxalines, polybenzimidazoles, polybenzoxazoles, polynorbornenes, poly(arylene ethers), polysilanes, parylenes, benzocyclobutenes, hydroxyl-(benzoxazole) copolymers, and poly(silarylene siloxanes).

Suitable epoxy compounds or resins for use in combination with azide/alkyne chemistry include, but not limited to, bifunctional and polyfunctional epoxy resins such as bisphenol A-type epoxy, cresol novolak epoxy, or phenol novolak epoxy. Another suitable epoxy resin is a multifunctional epoxy resin from Dainippon Ink and Chemicals, Inc. (sold under the product number HP-7200). When added to the formulation, the epoxy typically will be present in an amount up to 80% by weight.

Suitable cyanate ester resins include those having the generic structure

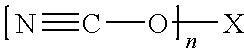

in which n is 1 or larger, and X is a hydrocarbon group. Exemplary X entities include, but are not limited to, bisphenol A, bisphenol F, bisphenol S, bisphenol E, bisphenol O, phenol or cresol novolac, dicyclopentadiene, polybutadiene, polycarbonate, polyurethane, polyether, or polyester. Commercially available cyanate ester materials include; AroCy L-10, AroCy XU366, AroCy XU371, AroCy XU378, XU71787.02L, and XU 71787.07L, available from Huntsman LLC; Primaset PT30, Primaset PT30 S75, Primaset PT60, Primaset PT60S, Primaset BADCY, Primaset DA230S, Primaset MethylCy, and Primaset LECY, available from Lonza Group Limited; 2-allyphenol cyanate ester, 4-methoxyphenol cyanate ester, 2,2-bis(4-cyanatophenol)-1,1,1,3,3,3-hexafluoropropane, bisphenol A cyanate ester, diallylbisphenol A cyanate ester, 4-phenylphenol cyanate ester, 1,1,1-tris(4-cyanatophenyl)ethane, 4-cumylphenol cyanate ester, 1,1-bis(4-cyanato-phenyl)ethane, 2,2,3,4,4,5,5,6,6,7,7-dodecafluoro-octanediol dicyanate ester, and 4,4′-bisphenol cyanate ester, available from Oakwood Products, Inc.

Other suitable cyanate esters include cyanate esters having the structure:

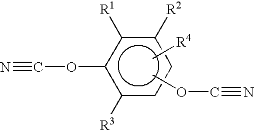

in which R¹ to R⁴ independently are hydrogen, C₁-C₁₀ alkyl, C₃-C₈ cycloalkyl, C₁-C₁₀ alkoxy, halogen, phenyl, phenoxy, and partially or fully fluorinated alkyl or aryl groups (an example is phenylene-1,3-dicyanate); cyanate esters having the structure:

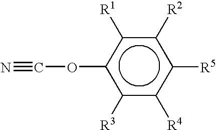

in which R¹ to R⁵ independently are hydrogen, C₁-C₁₀ alkyl, C₃-C₈ cycloalkyl, C₁-C₁₀ alkoxy, halogen, phenyl, phenoxy, and partially or fully fluorinated alkyl or aryl groups;

cyanate esters having the structure:

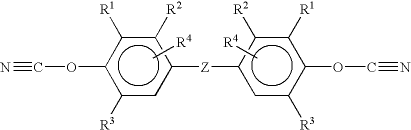

in which R¹ to R⁴ independently are hydrogen, C₁-C₁₀ alkyl, C₃-C₈ cycloalkyl, C₁-C₁₀ alkoxy, halogen, phenyl, phenoxy, and partially or fully fluorinated alkyl or aryl groups; Z is a chemical bond or SO₂, CF₂, CH₂, CHF, CHCH₃, isopropyl, hexafluoroisopropyl, C₁-C₁₀ alkyl, O, N═N, R⁸C═CR⁸ (in which R⁸ is H, C₁ to C₁₀ alkyl, or an aryl group), R⁸COO, R⁸C═N, R⁸C═N—C(R⁸)═N, C₁-C₁₀ alkoxy, S, Si(CH₃)₂ or one of the following structures:

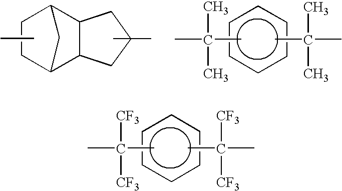

(an example is 4,4′ ethylidenebisphenylene cyanate having the commercial name AroCy L-10 from Vantico);

cyanate esters having the structure:

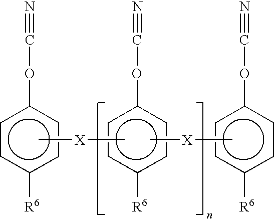

in which R⁶ is hydrogen or C₁-C₁₀ alkyl and X is CH₂ or one of the following structures

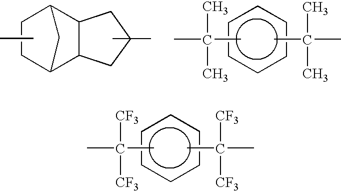

and n is a number from 0 to 20 (examples include XU1366 and XU71787.07, commercial products from Vantico);

cyanate esters having the structure: N≡C—O—R⁷—O—C≡N, and

cyanate esters having the structure: N≡C—O—R⁷, in which R⁷ is a non-aromatic hydrocarbon chain with 3 to 12 carbon atoms, which hydrocarbon chain may be optionally partially or fully fluorinated.

Suitable epoxy resins include bisphenol, naphthalene, and aliphatic type epoxies. Commercially available materials include bisphenol type epoxy resins (Epiclon 830LVP, 830CRP, 835LV, 850CRP) available from Dainippon Ink & Chemicals, Inc.; naphthalene type epoxy (Epiclon HP4032) available from Dainippon Ink & Chemicals, Inc.; aliphatic epoxy resins (Araldite CY179, 184, 192, 175, 179) available from Ciba Specialty Chemicals, (Epoxy 1234, 249, 206) available from Dow Corporation, and (EHPE-3150) available from Daicel Chemical Industries, Ltd.

Other suitable epoxy resins include cycloaliphatic epoxy resins, bisphenol-A type epoxy resins, bisphenol-F type epoxy resins, epoxy novolac resins, biphenyl type epoxy resins, naphthalene type epoxy resins, dicyclopentadienephenol type epoxy resins.

Epoxy is a preferred additional reactant with the azide/alkyne chemistry because propargylamines such as N,N,N′,N′-tetrapropargyl-m-phenylenedioxy-dianiline and N,N,N′,N′-tetrapropargylphenylene-diamine can play a dual role both in azide/alkyne chemistry and in epoxy curing as a monomer or as amine initiators, respectively.

When an epoxy compound is added as a reaction component, a curing or hardening agent for the epoxy may be required. Suitable curing agents include amines, polyamides, acid anhydrides, polysulfides, trifluoroboron, and bisphenol A, bisphenol F and bisphenol S, which are compounds having at least two phenolic hydroxyl groups in one molecule. A curing accelerator may also be used in combination with the curing agent. Suitable curing accelerators include imidazoles, such as 2-methylimidazole, 2-ethyl-4-methylimidazole, 4-methyl-2-phenylimidazole, and 1-cyanoethyl-2-phenylimidazolium trimellitate. The curing agents and accelerators are used in standard amounts known to those skilled in the art.

Suitable maleimide resins include those having the generic structure

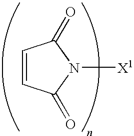

in which n is 1 to 3 and X¹ is an aliphatic or aromatic group. Exemplary X¹ entities include, poly(butadienes), poly(carbonates), poly(urethanes), poly(ethers), poly(esters), simple hydrocarbons, and simple hydrocarbons containing functionalities such as carbonyl, carboxyl, amide, carbamate, urea, ester, or ether. These types of resins are commercially available and can be obtained, for example, from Dainippon Ink and Chemical, Inc.

Additional suitable maleimide resins include, but are not limited to, solid aromatic bismaleimide (BMI) resins, particularly those having the structure

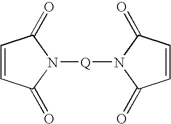

in which Q is an aromatic group.

Exemplary aromatic groups include

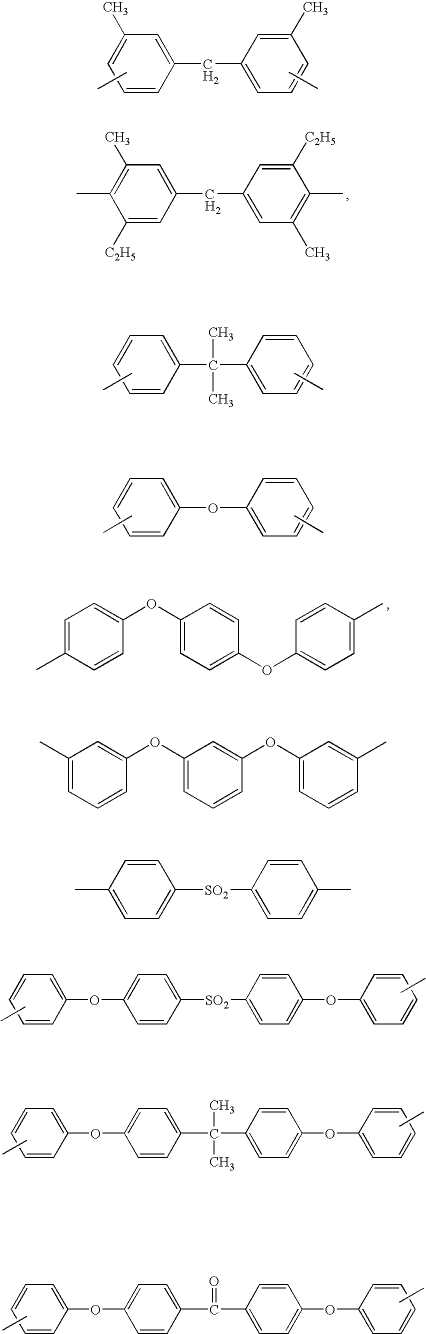

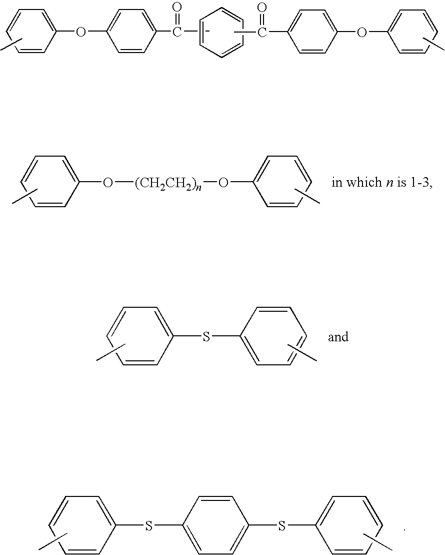

Bismaleimide resins having these Q bridging groups are commercially available, and can be obtained, for example, from Sartomer (USA) or HOS-Technic GmbH (Austria).

Other suitable maleimide resins include the following:

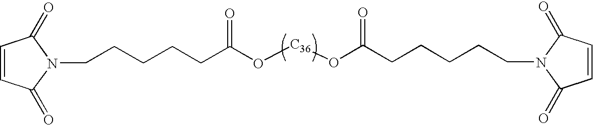

in which C₃₆ represents a linear or branched hydrocarbon chain (with or without cyclic moieties) of 36 carbon atoms;

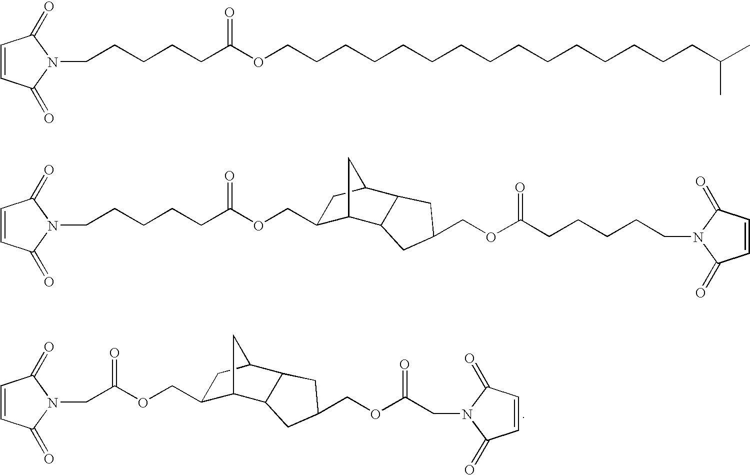

Suitable acrylate and methacrylate resins include those having the generic structure

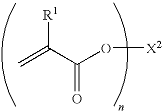

in which n is 1 to 6, R¹ is —H or —CH₃. and X² is an aromatic or aliphatic group. Exemplary X² entities include poly(butadienes), poly-(carbonates), poly(urethanes), poly(ethers), poly(esters), simple hydrocarbons, and simple hydrocarbons containing functionalities such as carbonyl, carboxyl, amide, carbamate, urea, ester, or ether. Commercially available materials include butyl (meth)acrylate, isobutyl (meth)acrylate, 2-ethyl hexyl (meth)acrylate, isodecyl (meth)acrylate, n-lauryl (meth)acrylate, alkyl (meth)-acrylate, tridecyl(meth)-acrylate, n-stearyl (meth)acrylate, cyclohexyl(meth)acrylate, tetrahydrofurfuryl-(meth)acrylate, 2-phenoxy ethyl(meth)-acrylate, isobornyl(meth)acrylate, 1,4-butanediol di(meth)acrylate, 1,6-hexanediol di(meth)acrylate, 1,9-nonandiol di(meth)acrylate, perfluorooctylethyl (meth)acrylate, 1,10 decandiol di(meth)-acrylate, nonylphenol polypropoxylate (meth)acrylate, and polypentoxylate tetrahydrofurfuryl acrylate, available from Kyoeisha Chemical Co., LTD; polybutadiene urethane dimethacrylate (CN302, NTX6513) and polybutadiene dimethacrylate (CN301, NTX6039, PRO6270) available from Sartomer Company, Inc; polycarbonate urethane diacrylate (ArtResin UN9200A) available from Negami Chemical Industries Co., LTD; acrylated aliphatic urethane oligomers (Ebecryl 230, 264, 265, 270, 284, 4830, 4833, 4834, 4835, 4866, 4881, 4883, 8402, 8800-20R, 8803, 8804) available from Radcure Specialities, Inc; polyester acrylate oligomers (Ebecryl 657, 770, 810, 830, 1657, 1810, 1830) available from Radcure Specialities, Inc.; and epoxy acrylate resins (CN104, 111, 112, 115, 116, 117, 118, 119, 120, 124, 136) available from Sartomer Company, inc. In one embodiment the acrylate resins are selected from the group consisting of isobornyl acrylate, isobornyl methacrylate, lauryl acrylate, lauryl methacrylate, poly(butadiene) with acrylate functionality and poly(butadiene) with methacrylate functionality.

Suitable vinyl ether resins are any containing vinyl ether functionality and include poly(butadienes), poly(carbonates), poly(urethanes), poly(ethers), poly(esters), simple hydrocarbons, and simple hydrocarbons containing functionalities such as carbonyl, carboxyl, amide, carbamate, urea, ester, or ether. Commercially available resins include cyclohexanedimethanol divinylether, dodecylvinylether, cyclohexyl vinylether, 2-ethylhexyl vinylether, dipropyleneglycol divinylether, hexanediol divinylether, octadecylvinylether, and butandiol divinylether available from International Speciality Products (ISP); Vectomer 4010, 4020, 4030, 4040, 4051, 4210, 4220, 4230, 4060, 5015 available from Sigma-Aldrich, Inc.

The curing agent for the additional reactant can be either a free radical initiator or an ionic initiator (either cationic or anionic), depending on whether a radical or ionic curing resin is chosen. The curing agent will be present in an effective amount. For free radical curing agents, an effective amount typically is 0.1 to 10 percent by weight of the organic compounds (excluding any filler), but can be as high as 30 percent by weight. For ionic curing agents or initiators, an effective amount typically is 0.1 to 10 percent by weight of the organic compounds (excluding any filler), but can be as high as 30 percent by weight. Examples of curing agents include imidazoles, tertiary amines, organic metal salts, amine salts and modified imidazole compounds, inorganic metal salts, phenols, acid anhydrides, and other such compounds. If the curing agent is an amine, the amine can be a functionality on the azide or alkyne compound.

Exemplary imidazoles include but are not limited to: 2-methyl-imidazole, 2-undecyl-imidazole, 2-heptadecyl imidazole, 2-phenylimidazole, 2-ethyl 4-methyl-imidazole, 1-benzyl-2-methylimidazole, 1-propyl-2-methyl-imidazole, 1-cyano-ethyl-2-methylimidazole, 1-cyanoethyl-2-ethyl-4-methyl-imidazole, 1-cyanoethyl-2-undecylimidazole, 1-cyanoethyl-2-phenylimidazole, 1-guanaminoethyl-2-methylimidazole, and addition products of an imidazole and trimellitic acid.

Exemplary tertiary amines include but are not limited to: N,N-dimethyl benzylamine, N,N-dimethylaniline, N,N-dimethyl-toluidine, N,N-dimethyl-p-anisidine, p-halogeno-N,N-dimethylaniline, 2-N-ethylanilino ethanol, tri-n-butylamine, pyridine, quinoline, N-methylmorpholine, triethanolamine, triethylenediamine, N,N,N′,N′-tetramethyl-butanediamine, N-methylpiperidine. Other suitable nitrogen containing compounds include dicyandiamide, diallylmelamine, diaminomalconitrile, amine salts, and modified imidazole compounds. The amine functionality on these compounds can be part of the azide or alkyne compounds.

Exemplary phenols include but are not limited to: phenol, cresol, xylenol, resorcine, phenol novolac, and phloroglucin.

Exemplary organic metal salts include but are not limited to: lead naphthenate, lead stearate, zinc naphthenate, zinc octolate, tin oleate, dibutyl tin maleate, manganese naphthenate, cobalt naphthenate, and acetyl aceton iron. Other suitable metal compounds include but are not limited to: metal acetoacetonates, metal octoates, metal acetates, metal halides, metal imidazole complexes, Co(II)(acetoacetonate), Cu(II)(acetoacetonate), Mn(II)(acetoacetonate), Ti(acetoacetonate), and Fe(II)(acetoacetonate). Exemplary inorganic metal salts include but are not limited to: stannic chloride, zinc chloride and aluminum chloride.

Exemplary peroxides include but are not limited to: benzoyl peroxide, lauroyl peroxide, octanoyl peroxide, butyl peroctoate, dicumyl peroxide, acetyl peroxide, para-chlorobenzoyl peroxide and di-t-butyl diperphthalate;

Exemplary acid anhydrides include but are not limited to: maleic anhydride, phthalic anhydride, lauric anhydride, pyromellitic anhydride, trimellitic anhydride, hexahydrophthalic anhydride; hexahydropyromellitic anhydride and hexahydrotrimellitic anhydride.

Exemplary azo compounds include but are not limited to: azoisobutylonitrile, 2,2′-azobispropane, 2,2′-azobis(2-methylbutanenitrile), m,m′-azoxystyrene. Other suitable compounds include hydrozones; adipic dihydrazide and BF3-amine complexes.

In some cases, it may be desirable to use more than one type of cure, for example, both ionic and free radical initiation, in which case both free radical cure and ionic cure resins can be used in the composition. Such a composition would permit, for example, the curing process to be started by cationic initiation using UV irradiation, and in a later processing step, to be completed by free radical initiation upon the application of heat

In some systems in addition to curing agents, curing accelerators may be used to optimize the cure rate. Cure accelerators include, but are not limited to, metal napthenates, metal acetylacetonates (chelates), metal octoates, metal acetates, metal halides, metal imidazole complexes, metal amine complexes, triphenylphosphine, alkyl-substituted imidazoles, imidazolium salts, and onium borates.

FILLERS FOR AZIDE/ALKYNE COMPOSITIONS. Depending on the end application, one or more fillers may be included in the azide/alkyne compositions and usually are added for improved rheological properties and stress reduction. Examples of suitable nonconductive fillers include alumina, aluminum hydroxide, silica, fused silica, fumed silica, vermiculite, mica, wollastonite, calcium carbonate, titania, sand, glass, barium sulfate, zirconium, carbon black, organic fillers, and halogenated ethylene polymers, such as, tetrafluoroethylene, trifluoroethylene, vinylidene fluoride, vinyl fluoride, vinylidene chloride, and vinyl chloride. Examples of suitable conductive fillers include carbon black, graphite, gold, silver, copper, platinum, palladium, nickel, aluminum, silicon carbide, boron nitride, diamond, and alumina. These conductive fillers also act as synergistic catalysts with the above described copper catalysts.

The filler particles may be of any appropriate size ranging from nano size to several mm. The choice of such size for any particular end use is within the expertise of one skilled in the art. Filler may be present in an amount from 10 to 90% by weight of the total composition. More than one filler type may be used in a composition and the fillers may or may not be surface treated. Appropriate filler sizes can be determined by the practitioner, but, in general, will be within the range of 20 nanometers to 100 microns.

Azide/Alkyne Chemistry with Additional Polymerizable Functionality. The triazole compound resulting from the polymerization of the azide/alkyne chemistry can be designed to contain one or more additional polymerizable functionalities. These compounds can be prepared by the reaction of an azide monomer and/or an alkyne monomer that contains an additional reactive functionality, such as epoxy, maleimide, acrylate, methacrylate, cyanate ester, vinyl ether, thiol-ene, fumarate and maleate compounds, and compounds that contain carbon to carbon double bonds attached to an aromatic ring and conjugated with the unsaturation in the aromatic ring. The additional functionality is left unreacted in the mild reaction conditions for the azide/alkyne reaction. In these compounds, the triazole moiety serves as a linker between the other reactive functionalities as well as an adhesion promoter.

Azide/Alkyne Chemistry Using the Metal Salt of an Organic Acid or the Metal Salt of a Maleimide Acid as the Catalyst. In another embodiment, the process of this invention can use the metal salt of an organic acid or the metal salt of a maleimide as the catalyst.

The metal salts of organic acids, may be either mono-functional or poly-functional, that is, the metal element may have a valence of one, or a valence of greater than one. The metal elements suitable for coordination in the salts include lithium (Li), sodium (Na), magnesium (Mg), potassium (K), calcium (Ca), scandium (Sc), titanium (Ti), vanadium (V), chromium (Cr), manganese (Mn), iron (Fe), cobalt (Co), nickel (Ni), copper (Cu), zinc (Zn), palladium (Pd), platinum (Pt), silver (Ag), gold (Au), mercury (Hg), aluminum (Ai), and tin (Sn).

The organic acids from which the metal salts are derived may be either mono-functional or poly-functional. In one embodiment, the organic acids are difunctional. The organic acid can range in size up to 20 carbon atoms and in one embodiment; the organic acid contains four to eight carbon atoms. The organic acid may be either saturated or unsaturated. Examples of suitable organic acids include the following, their branched chain isomers, and halogen-substituted derivatives: formic, acetic, propionic, butyric, valeric, caproic, caprylic, carpric, lauric, myristic, palmitic, stearic, oleic, linoleic, linolenic, cyclohexanecarboxylic, phenylacetic, benzoic, o-toluic, m-toluic, p-toluic, o-chlorobenzoic, m-chlorobenzoic, p-chlorobenzoic, o-bromo-benzoic, m-bromobenzoic, p-bromobenzoic, o-nitobenzoic, m-nitrobenzoic, p-nitrobenzoic, phthalic, isophthalic, terephthalic, salicylic, p-hydroxybenzoic, anthranilic, m-aminobenzoic, p-aminobenzoic, o-methoxybenzoic, m-methoxybenzoic, p-methoxybenzoic, oxalic, malonic, succinic, glutaric, adipic, pimelic, suberic, azelaic, sebacic, maleic, fumaric, hemimellitic, trimellitic, trimesic, malic, and citric.

Many, if not all, of these carboxylic acids are commercially available or can be readily synthesized by one skilled in the art. The conversion to metal salts is known art. The metal salts of these carboxylic acids are generally solid materials that can be milled into a fine powder for incorporating into the chosen resin composition.

The metal salt of a maleimide acid is prepared by (i) reacting a molar equivalent of maleic anhydride with a molar equivalent of an amino acid to form an amic acid, (ii) dehydrating the amic acid to form a maleimide acid, and (iii) converting the maleimide acid to the metal salt.

Suitable amino acids can be aliphatic or aromatic, and include, but are not limited to, glycine, alanine, 2-aminoisobutyric acid, valine, tert-leucine, norvaline, 2-amino-4-pentenoic acid, isoleucine, leucine, norleucine, beta-alanine, 5-aminovaleric acid, 6-aminocaproic acid, 7-aminoheptanoic acid, 8-aminocaprylic acid, 11-amino-undecanoic acid, 12-aminododecanoic acid, 2-phenylglycine, 2,2′-diphenylglycine, phenylalanine, alpha-methyl-DL-phenylalanine, and homophenylalanine.

In order to prepare the metal salt of a maleimide, maleic anhydride is dissolved in an organic solvent, such as acetonitrile, and this solution added to a one mole equivalent of the desired amino acid. The mixture is allowed to react, typically for about three hours, at room temperature, until white crystals are formed. The white crystals are filtered off, washed with cold organic solvent (acetonitrile) and dried to produce the amic acid adduct. The amic acid adduct is mixed with base, typically triethylamine, in a solvent, such as toluene. The mixture is heated to 130° C. for two hours to dehydrate the amic acid and form the maleimide ring. The organic solvent is evaporated and sufficient 2M HCL added to reach pH 2. The product is then extracted with ethyl acetate and dried, for example, over MgSO₄, followed by evaporation of the solvent.

The product from the above reaction is a compound containing both maleimide and carboxylic acid functionalities (hereinafter referred to as a “maleimide acid”). It will be understood by those skilled in the art that the hydrocarbon (aliphatic or aromatic) moiety separating the maleimide and acid functionalities is the derivative of the starting amino acid used to make the compound.

The conversion of the maleimide acid to a metal salt is known art. In general, the conversion of the carboxylic acid functionality is conducted by combining the maleimide acid with a metal nitrate or halide. The maleimide acid is mixed with water at 10° C. or lower and sufficient base, for example, NH4OH (assay 28-30%), is added to raise the pH to about 7.0. A solution of a stoichiometric amount of metal nitrate or halide is prepared and is added to the reaction slurry over a short time (for example, five minutes) while maintaining the reaction temperature at or below 10° C. The reaction is held at that temperature and mixed for several hours, typically two to three hours, after which the mixture is allowed to return to room temperature and mixed for an additional 12 hours at room temperature. The precipitate product, the metal salt of a maleimide, is filtered and washed with water (three times) and then with acetone (three times), and dried in a vacuum oven for 48 hours at about 45° C.

The organic metal salt will be loaded into the resin composition at a loading of 0.01% to 20% by weight of the formulation. In one embodiment, the loading is around 0.1% to 1.0% by weight.

Curable compositions, before polymerization, and cured compositions, after polymerization, relative to the polymerization using metal and maleimide salts comprise a first reactant having an azide functionality, a second reactant having a terminal alkyne functionality, a metal salt of an organic acid or the metal salt of a maleimide acid, and optionally a filler.

AZIDE/ALKYNE CHEMISTRY CONTAINING SILANE FUNCTIONALITY. It is possible to add silane functionality to the triazole resulting from the azide/alkyne reaction disclosed in this specification, by choosing an alkyne reactant that contains both terminal alkyne functionality and silane functionality, or an azide reactant that contains both azide functionality and silane functionality, or both azide and alkyne can contain silane functionality. The molecular weight of these compounds may vary and readily can be adjusted for a particular curing profile so that the compound does not volatilize during curing. Exemplary second reactants containing silane functionality and terminal alkyne functionality include, but are not limited to, O-(propargyloxy)-N-(triethoxysilylpropyl) urethane and N-(propargylamine)-N-(triethoxysilylpropyl) urea. The compositions containing these compounds work very well as adhesion promoters due to the presence of the silane.

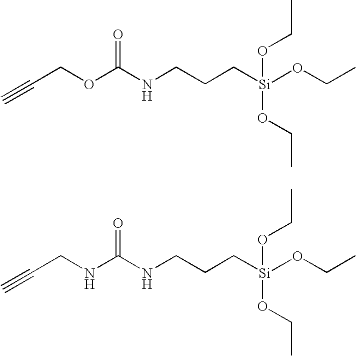

AZIDE/ALKYNE CHEMISTRY USED FOR FILM ADHESIVES. Film adhesives utilizing the azide/alkyne chemistry can be prepared from compositions containing a base polymer (hereinafter “polymer” or “base polymer”) and azide and/or alkyne functionality. The system can be segregated into several classes: (1) a base polymer blended with an independent azide compound and an independent alkyne compound; (2) a base polymer substituted with pendant azide functionality, blended with an independent alkyne compound, and optionally an independent azide compound; (3) a base polymer substituted with pendant alkyne functionality, blended with an independent azide compound and optionally an independent alkyne compound; (4) a base polymer substituted with pendant alkyne and azide functionality, or a combination of a base polymer substituted with pendant alkyne functionality and a base polymer substituted with pendant azide functionality, optionally blended with an independent alkyne compound, or an independent azide compound, or both. Preferably, there will be a 1:1 molar ratio of alkyne to azide functionality; however, the molar ratio can range from 0.01-1.0 to 1.0-0.01.

A suitable base polymer in the polymer system of the film adhesive is prepared from acrylic and/or vinyl monomers using standard polymerization techniques. The acrylic monomers that may be used to form the base polymer include α,β-unsaturated mono and dicarboxylic acids having three to five carbon atoms and acrylate ester monomers (alkyl esters of acrylic and methacrylic acid in which the alkyl groups contain one to fourteen carbon atoms). Examples are methyl acryate, methyl methacrylate, n-octyl acrylate, n-nonyl methacrylate, and their corresponding branched isomers, such as, 2-ethylhexyl acrylate. The vinyl monomers that may be used to form the base polymer include vinyl esters, vinyl ethers, vinyl halides, vinylidene halides, and nitriles of ethylenically unsaturated hydrocarbons. Examples are vinyl acetate, acrylamide, 1-octyl acrylamide, acrylic acid, vinyl ethyl ether, vinyl chloride, vinylidene chloride, acrylonitrile, maleic anhydride, and styrene.

Another suitable base polymer in the polymer system of the inventive film adhesive is prepared from conjugated diene and/or vinyl monomers using standard polymerization techniques. The conjugated diene monomers that may be used to form the polymer base include butadiene-1,3,2-chlorobutadiene-1,3, isoprene, piperylene and conjugated hexadienes. The vinyl monomers that may be used to form the base polymer include styrene, α-methylstyrene, divinylbenzene, vinyl chloride, vinyl acetate, vinylidene chloride, methyl methacrylate, ethyl acrylate, vinylpyridine, acrylonitrile, methacrylonitrile, methacrylic acid, itaconic acid and acrylic acid.

Alternatively, the base polymer can be purchased commercially. Suitable commercially available polymers include acrylonitrile-butadiene rubbers from Zeon Chemicals and styrene-acrylic copolymers from Johnson Polymer.

In those systems in which the base polymer is substituted with alkyne and/or azide functionality, the degree of substitution can be varied to suit the specific requirements for cross-link density in the final applications. Suitable substitution levels range from 6 to 500, preferably from 10 to 200.

The base polymer, whether substituted or unsubstituted will have a molecular weight range of 2,000 to 1,000,000. The glass transition temperature (Tg) will vary depending on the specific base polymer. For example, the Tg for butadiene polymers ranges from −100° C. to 25° C., and for modified acrylic polymers, from 15° C. to 50° C.

Other materials, such as adhesion promoters (e.g. epoxides, silanes), dyes, pigments, and rheology modifiers, may be added as desired for modification of final properties. Such materials and the amounts needed are within the expertise of those skilled in the art.

Exemplary butadiene/acrylo-nitrile base polymers containing pendant alkyne functionality include:

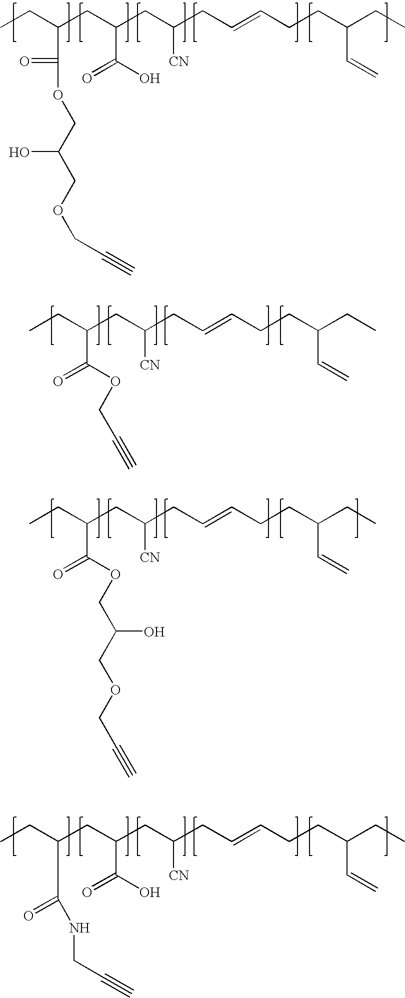

Exemplary poly(vinylacetylene) base polymers containing pendant alkyne functionality can be prepared according to the synthetic procedure of B. Helms, J. L. Mynar, C. J. Hawker, J. M. Frechet, J. Am. Chem. Soc., 2004, 126(46), 15020-15021 as shown here:

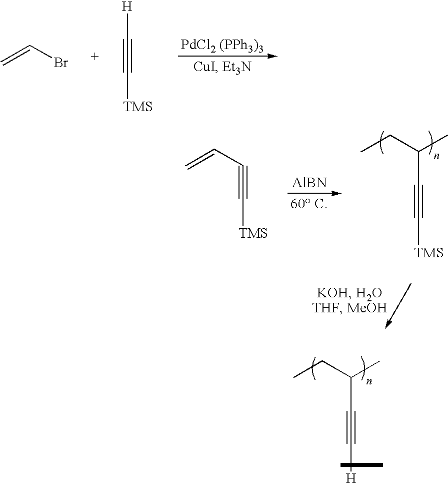

Exemplary hydroxylated styrene/butadiene base polymers with pendant azide functionality include:

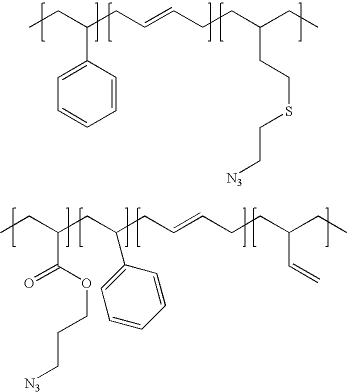

Exemplary poly(meth)acryate base polymers with pendent azide functionality include:

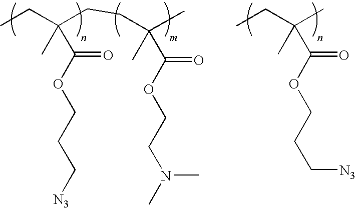

The synthetic procedures for poly(meth)acryale base polymers with pendent azide functionality are conducted according to B. S. Sumerlin, N. V. Tsarevsky, G. Louche, R. Y. Lee, and K. Matyjaszewski, Macromolecules 2005, 38, 7540-7545.

Exemplary polystyrene base polymers with azide functionality include the following, in which n is an integer of 1 to 500.

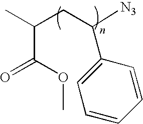

The synthetic procedures for polystyrene base polymers with azide functionality are conducted according to J-F. Lutz, H. G. Borner, K. Weichenhan, Macromolecular Rapid Communications, 2005, 26, 514-518.

### EXAMPLES

### Example 1

### Curing Behavior of Azide and Alkyne Monomers in Bulk Phase without Catalysts

To get a better understanding of structure-cure temperature relationship, several structurally different alkynes were reacted in combination with dimer azide using DSC to react and cure the reactants. Tripropargylamine and nonadiyne were purchased from Aldrich; the other compounds were synthesized in-house. The results are reported in Table 1 and indicate that there is a strong dependence of cure temperature on the alkyne structure. All propargyl ethers, entries 1, 2, and 3, cured at 150° C. No significant effect of degree of branching of alkynes on cure temperature was observed (entries 1 and 2 compared to 3). In contrast to the propargyl ethers, the propargyl amines showed higher cure temperatures (entries 4 and 5). When the all-carbon alkyne, nonadiyne, was used, the cure temperature was the highest (entry 6).

The reactivity order of alkynes in the bulk phase uncatalyzed azide/alkyne chemistry is shown here:

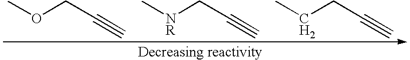

TABLE 1
CURING STUDY OF DIFFERENT ALKYNES WITH
DIMER AZIDE WITHOUT CU CATALYST

| | | DSC Peak |
|---|---|---|
| Entry | Resin Composition | Temperature |
| 1 | Dimer azide and resorcinol propargyl ether | 148° C. |
| 2 | Dimer azide and bisphenol-A propargyl ether | 150° C. |
| 3 | Dimer azide and 1,1,1-trishydroxyphenylethane | 150° C. |
| | propargyl ether | |
| 4 | Dimer azide and tripropargylamine | 165° C. |
| 5 | Dimer azide and N,N,N′,N′-tetrapropargyl-m- | 159° C. |
| | phenylenedioxydianiline | |
| 6 | Dimer azide and nonadiyne | 186° C. |

### Example 2

### Catalytic Effect of Cu(I) Species in Bulk Phase Reactions

Three commercially available Cu(I) catalysts, CuI, CuSBu, and CuPF₆(CH₃CN)₄, were screened to target a DSC peak temperature of approximately 100° C. compared to a control using no catalyst. The results are reported in Table 2. All of the catalysts used in the study decreased the DSC peak temperature of the formulations of entries 2, 3, 4, 10 compared to the control, entry 1; of the formulations of entries 6, 7 compared to the control, entry 5; the formulation of entry 9 compared to the control, entry 8. The magnitude of reduction in DSC peak temperature depended on the catalyst loading, entry 2 compared to entry 10, with higher loading giving the lowest peak temperature.

In addition to lowering the DSC peak temperatures, these Cu(I) catalysts also narrowed the cure profile considerably, making them more suitable for snap (fast) cure (see ΔT in entries 4, 6, 7, 9, compared with respective controls). With CuI and CuPF₆(CH₃CN)₄ catalysts, early onset (Tₒₙₛₑₜ<60° C.) was observed with some azides and alkynes (see Tₒₙₛₑₜ in entries 2,3). The early onset could be addressed by the use of CuSBu catalyst having sulfur ligands (entries 4, 7). Even in the cases where CuI catalyst was used, the onset temperature could be increased in systems containing azides possessing polyether backbone (entry 6, Tₒₙₛₑₜ=117° C.), and when catalyst loading was reduced (entry 10 compared to entry 2).

TABLE 2
CATALYTIC EFFECT OF CU(I) SPECIES ON VARIOUS
AZIDE/ALKYNE RESIN COMPOSITIONS

| | | DSC | DSC | |
|---|---|---|---|---|
| | | Peak | Onset | Onset- |
| | | Temp | Temp | to-Peak |
| Entry | Resin System | T peak | T onset | ΔT |
| 1 | Dimer azide + | 165° C. | 118° C. | 47° C. |
| | tripropargylamine | | | |
| | no catalyst (control) | | | |
| 2 | Dimer azide + | 114° C. | 56° C. | 58° C. |
| | tripropargylamine + | | | |
| | CuI (1.0 wt %) | | | |
| 3 | Dimer azide + | 122° C. | 44° C. | 78° C. |
| | tripropargylamine + | | | |
| | CuPF₆(CH₃CN)₄ (1.0 wt %) | | | |
| 4 | Dimer azide + | 124° C. | 99° C. | 25° C. |
| | tripropargylamine + | | | |
| | CuSBu (1.0 wt %) | | | |
| 5 | Polyether azide + | 186° C. | 140° C. | 46° C. |
| | tripropargylamine, | | | |
| | no catalyst (control) | | | |
| 6 | Polyether azide + | 137° C. | 117° | 20° C. |
| | tripropargylamine + | | | |
| | CuI (1.0 wt %) | | | |
| 7 | Polyether azide + | 124° C. | 106° C. | 18° C. |
| | tripropargylamine + | | | |
| | CuSBu (1.0 wt %) | | | |
| 8 | Polyether azide + N,N,N′,N′- | 180° C. | 128° C. | 52° C. |
| | tetrapropargyl-m-phenylenedioxy- | | | |
| | dianiline, no catalyst (control) | | | |
| 9 | Polyether azide + N,N,N′,N′- | 122° C. | 94° C. | 28° C. |
| | tetrapropargyl-m-phenylenedioxy- | | | |
| | dianiline + CuI (1.0 wt %) | | | |
| 10 | Dimer azide + | 141° C. | 103° C. | 38° C. |
| | tripropargylamine + | | | |
| | CuI (0.3 wt %) | | | |

### Example 3

### Effect of Cu(I) and Cu(II) Catalysts on Curing Temperature

Eight different Cu(I) catalysts and one Cu(II) catalyst without reducing agent were examined for their effect on the curing temperature of the azide/alkyne azide/alkyne chemistry using the same resin composition of dimer azide and bisphenol E propargyl ether in a 1:1 equivalent ratio with one weight % of the catalyst. Entry 1 is the control without catalyst, entries 2 to 9 are the Cu(I) catalysts, and entry 10 is the Cu(II) catalyst. Most Cu(I) catalysts significantly reduced the curing temperature (entries 2, 3, 4, 5, 6, 7), and some catalyzed the chemistry so dramatically that the resin composition gelled immediately after mixing at room temperature (entries 2 and 3, although no narrowing of DSC peaks were observed. The Cu(II) catalyst without a reducing agent unexpectedly also reduced the the curing temperature. The results are reported in TABLE 3.

TABLE 3
EFFECT OF CU CATALYSTS ON CURING TEMPERATURE

| | | DSC | | | |
|---|---|---|---|---|---|
| | | Tpeak | Tonset | ΔT | ΔH |
| Entry | Composition Description | (° C.) | (° C.) | (° C.) | (J/g) |
| 1 | Dimer azide + Bisphenol-E | 151 | 104 | 47 | 604 |
| | propargyl ether (1:1 eq) no catalyst | | | | |
| | (control) | | | | |
| 2 | Dimer azide + Bisphenol-E | Gelled rapidly (<5 minutes) at | | | |
| | propargyl ether (1:1 eq) + 1.0 wt % | room temperature, was not able | | | |
| | Bis(trimethylsilylacetylene | to performed DSC. | | | |
| | (hexafluoroacetylacetonate) Copper (I) | | | | |
| 3 | Dimer azide + Bisphenol-E | Gelled rapidly (<5 minutes) at | | | |
| | propargyl ether (1:1 eq) + 1.0 wt % | room temperature, was not able | | | |
| | (Ethylcyclopentadienyl) | to performed DSC. | | | |
| | triphenylphosphine Copper (I) | | | | |
| 4 | Dimer azide + Bisphenol-E | 100 | 50 | 50 | 578 |
| | propargyl ether (1:1 eq) + 1.0 wt % | | | | |
| | CuI | | | | |
| 5 | Dimer azide + Bisphenol-E | 110 | 69 | 41 | 470 |
| | propargyl ether (1:1 eq) + 1.0 wt % | | | | |
| | Copper (I) Thiocyanate | | | | |
| 6 | Dimer azide + Bisphenol-E | 114 | 65 | 49 | 374 |
| | propargyl ether (1:1 eq) + 1.0 wt % | | | | |
| | Thiophenol Copper (I) | | | | |
| 7 | Dimer azide + Bisphenol-E | 119 | 82 | 37 | 538 |
| | propargyl ether (1:1 eq) + 1.0 wt % | | | | |
| | CuSBu | | | | |
| 8 | Dimer azide + Bisphenol-E | 146 | 97 | 49 | 634 |
| | propargyl ether (1:1 eq) + 1.0 wt % | | | | |
| | Copper (I) Sulfide, Cu₂S | | | | |
| 9 | Dimer azide + Bisphenol-E | 148 | 99 | 48 | 481 |
| | propargyl ether (1:1 eq) + 1.0 wt % | | | | |
| | Bromotris(triphenylphosphine) | | | | |
| | Copper (I) | | | | |
| 10 | Dimer azide + Bisphenol-E | 111 | 86 | 25 | 433 |
| | propargyl ether (1:1 eq) + 1.0 wt % | | | | |
| | Copper Adipate | | | | |

### Example 4

### Effect of Metal Filler on Curing Temperature

When a metal filler is added to the azide/alkyne reaction catalyzed by Cu(I), there is a reduction in curing temperature greater than what is achieved when just the catalyst is used. Several formulations of azide/alkyne and Cu(I) catalyst, with and without silver flakes as a filler were tested by DSC for the peak (curing) temperature and the results reported in TABLE 4. The azides and alkynes for each formulation were present in a 1:1 molar ratio and are identified in the table. For those samples containing silver, the silver was present at 75 parts by weight of the total formulation, and was provided as SF98 from Ferro Corp. As used in the table, “eq” means molar equivalent and “wt %” means weight percent.

Entries 1 to 3 of TABLE 4 show a reduction in curing temperature when a silver filler was added to the formulation. Entries 4 and 5 show the effect of the level of catalyst on the curing temperature. In entry 4, the catalyst CuSBu was present at 1.0 weight percent and in entry 5 at 0.1 weight percent. The two samples, with and without silver filler, of entry 4 showed a larger reduction in curing temperature than the samples of entry 5, with and without silver filler.

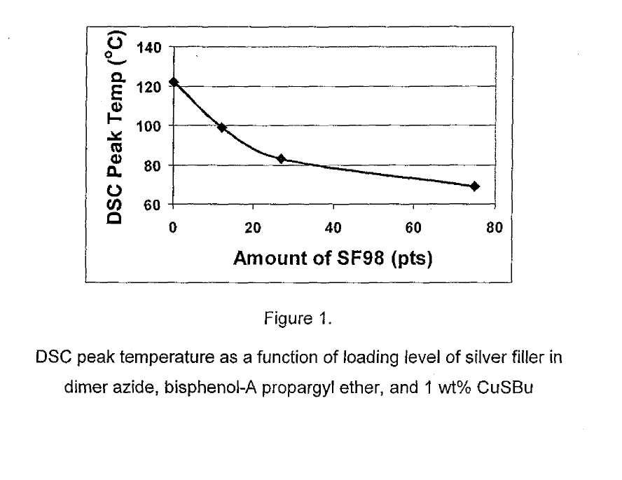

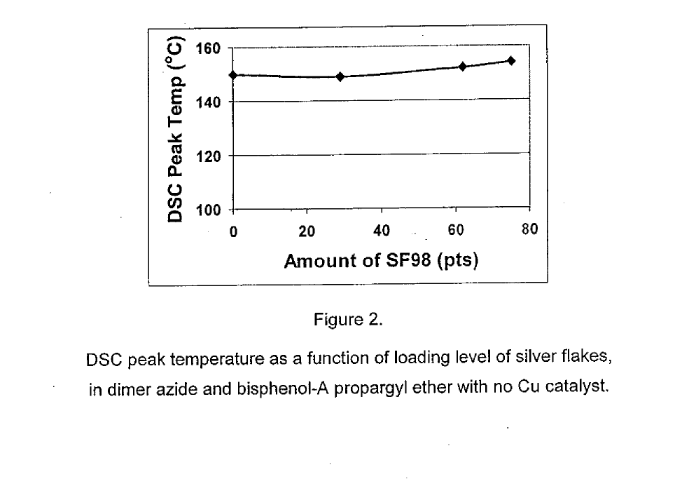

Additional samples were prepared to test the effect of the level of metal filler. The results are depicted in FIG. 1 and show that when the level of copper catalyst is kept constant and the level of silver flake is increased, the curing temperature is reduced. Samples without copper catalyst were also prepared and tested for the effect of silver. The results are depicted in FIG. 2 and show that Ag filler alone, in the absence of Cu catalyst, did not reduce the reaction temperature. This further proves that the effect between the Cu catalyst and silver filler is synergistic.

TABLE 4
DSC PEAKS OF AZIDE/ALKYNE/CU(I) COMPOSITIONS
WITH AND WITHOUT AG FILLER

| | | DSC Peak | | | |
|---|---|---|---|---|---|
| | | Temperature | | | |
| | | (° C.) | | ΔH (J/g) | |
| | | w/o | | w/o | |
| Entry | Resin Composition | Ag | Ag | Ag | Ag |
| 1 | Dimer azide + Tripropargylamine | 143 | 85 | 763 | 211 |
| | (1:1 eq.) + 1 wt % CuI | | | | |
| 2 | Dimer azide + Resorcinol propargyl | 91 | 57 | 605 | 112 |
| | ether (1:1 eq.) + 0.2 wt % CuI | | | | |
| 3 | Dimer azide + Bisphenol-A propargyl | 133 | 69 | 596 | 124 |
| | ether (1:1 eq.) + 1 wt % CuSBu | | | | |
| 4 | Dimer azide + Bisphenol-E propargyl | 119 | 62 | 538 | 98 |
| | ether (1:1 eq.) + 1.0 wt % CuSBu | | | | |
| 5 | Dimer azide + Bisphenol-E propargyl | 130 | 76 | 583 | 156 |
| | ether (1:1 eq.) + 0.1 wt % CuSBu | | | | |
| 6 | Dimer azide + Alkyne Ex. 12 | 155 | 124 | 206 | 105 |
| | (1:1 eq.) + 1 wt % CuI | | | | |
| 7 | Polyether azide + Resorcinol | 142 | 94 | 250 | 64 |
| | propargyl ether (1:1 eq.) + 1 wt % | | | | |
| | CuI | | | | |

### Example 5

### Adhesion Performance Testing of Silver Filled Compositions

Die shear tests were performed with the azide/alkyne resin systems to check adhesion of azide/alkyne chemistry to metal leadframes, substrates for semiconductor chips or dies, used extensively in electronic packaging. Silicon semiconductor dies 200 mil×200 mil were adhered to the metal leadframes with formulations containing azides, alkynes, Ag filler, and Cu catalyst. Copper, Silver, and PPF leadframes were used as the metal substrates. Combinations of different azides and alkynes showed different die shear values and different failure modes, indicating that the adhesion to metal strongly depends on the backbone structure of the azide/alkyne chemistry resins. The systems containing dimer azide and bisphenol-A propargyl ether, and dimer azide and bisphenol-E propargyl ether, showed very good adhesion to the PPF leadframe (25 kg force and 27 kg force, respectively, for a 200 mil×200 mil silica die on PPF leadframe, tested at room temperature) that was comparable to Ablebond 8200C, (a commercial product of Ablestik Laboratories), which had a die shear strength of 30 kg force under the same conditions. The failure mode was cohesive failure.

### Example 6

### Azide/Alkyne Film Filled with Silver

A film was made from dimer azide+bisphenol-A propargyl ether (1.1 eq.)+1.0 wt % CuSBu and 75 pts silver filler by blending the components and curing at 175° C. (in air). The film was very flexible, with a Tg of approximately 22° C., even though it was highly filled with silver filler. Mechanical property of the film and its dependence on temperature were evaluated by RSAIII instrumentation. Two samples were cured at 175° C., one for 30 minutes and one for 60 minutes; the modulus and the glass transition temperature remained the same for both.

### Example 7

### Triazole Epoxy Hybrid

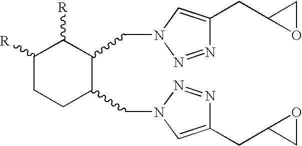

To a solution of azide dimer azide (10 g, 17 mmol) in a mixture of t-BuOH (50 mL) and water (25 mL) was added glycidyl propargyl ether (3.9 g, 35 mmol). To this stirred mixture were added concentrated aqueous solutions of CuSO₄.5H₂O (85 mg, 0.34 mmol) and Na ascorbate (337 mg, 1.7 mmol) (immediate color change was observed from light yellow to yellowish orange). After stirring at the same temperature overnight, ethyl acetate (400 mL) was added and the product mixture filtered. The organic layer was washed with water (100 ml×3) followed by brine. After drying over anhydrous MgSO₄, the solvent was evaporated and the product dried using Kugelrohr distillation set up for two hours at room temperature to give epoxy product (8.2 g, 60%) as a viscous liquid. This hybrid resin was found to cure at ˜160° C. in the absence of any added amine catalysts, indicating that the polymerization may be initiated by the fairly nucleophilic triazole functionality.

### Example 8

### Compatibility of Azide/Alkyne Chemistry with Epoxy and Other Resins

The compatibility of azide/alkyne chemistry with an epoxy resin was explored by mixing polyether azide (N,N,N′,N′-tetrapropargylphenylene-diamine, prepared from dimer azide and propargyl amine) and bis-F epoxy, and tracking the characteristic IR peaks of azide (2100 cm⁻¹), alkyne (3300 cm⁻¹) and the oxirane band (930-890 cm⁻¹) in the temperature range (25-280° C.).

The normalized intensity profiles of azide, alkyne and epoxy bands were plotted against temperature and disclosed that in the temperature range 70-120° C., the main changes were the decrease of the alkyne (—C≡C—H) and azide band intensities at 3350-3150 cm⁻¹ and 2200-2000 cm⁻¹ frequency region, respectively, confirming that the first DSC curing peak was coming from azide/alkyne chemistry. At higher temperatures (>180° C.), the absorption intensity of the oxirane group (930-890 cm⁻¹) started to decrease with the maximum reaction rate observed in the 220-260° C. temperature range, indicating the epoxy reaction was occurring in this temperature range.

### Example 9

### Synthesis of Dimer Azide

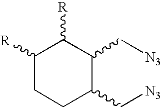

To a solution of dimer diol (151 g, 0.28 mol) in CH₂Cl₂ (1000 mL) at 0° C. was added triethylamine (118 mL, 0.85 mol) and stirred for 15 minutes. To this mixture was added MeSO₂Cl (48 mL, 0.62 mol) slowly dropwise over a period of 15 minutes. The mixture was stirred at the same temperature for one hour and at room temperature for two hours 30 minutes. CH₂Cl₂ was evaporated and ethyl acetate (1000 mL) was added to the residue. The mixture was washed with water (3×300 mL), brine and dried over anhydrous MgSO₄. Solvent evaporation followed by drying over Kugelrohr distillation set up for three hours furnished the mesylate product (189 g, 97%).

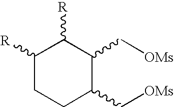

To a solution of the above mesylate (130 g, 0.19 mol) in N,N-dimethylformamide (hereinafter DMF) (1400 mL) was added sodium azide (25 g, 0.39 mol) and stirred at room temperature for 15 minutes. This mixture was stirred on a preheated temperature bath at 85° C. for five-eight hours (monitored by TLC) using a mechanical stirrer (medium speed stirring). The TLC analysis showed the disappearance of the starting material at this stage and a new non-polar spot started appearing as visualized with iodine. After cooling to room temperature, 5% aqueous NaOH (300 mL) was added (to assure no hydrazoic acid) followed by water (1500 mL). The product was extracted with 1:1 ethyl acetate:heptane (400 mL×3). The organic layer was washed thoroughly with water (3×500 mL) to remove residual DMF. After washing with a brine solution, the organic extract was dried over anhydrous MgSO₄ and the solvent evaporated at room temperature. The product was dried at 40° C. using Kugelrohr distillation set up for three hours to give the azide (103 g, 94%).

Dimer azide has a 16:1 ratio of carbon to azide functionality. The thermal stability of this azide was good under the normal resin cure temperature range with a decomposition temperature, T_{d}, of 270° C. The heat of decomposition, H_{d}, was 880 J/g, which is higher than the acceptable limit of 300 J/g. This indicates that the number of carbons (or other atoms of similar size) per energetic functionality is not providing sufficient dilution to bring the heat of decomposition to 300 J/g.

### Example 10

### Synthesis of Polyether Azide

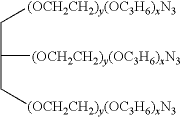

To a solution of glycerol ethoxylate co-propoxylate trial (74 g, 28 mmol) in CH₂Cl₂ (600 mL) (Mn 2600) was added triethyl-amine (20 mL, 142 mmol). This mixture was cooled to 0° C. and methanesulfonyl chloride was added dropwise. The resulting mixture was stirred at the same temperature for one hour and at room temperature for one hour. CH₂Cl₂ was evaporated and ethyl acetate (800 mL) was added to the residue. The organic layer was washed with water several times (3×300 mL). After drying over anhydrous MgSO₄, the solvent was evaporated and the product dried over Kugelrohr for three hours to afford the mesylate (71 g, 88%).

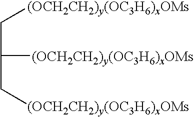

To a solution of the mesylate (71 g, 25 mmol) in DMF (500 mL) was added NaN₃ (5 g, 78 mmol) and the mixture was stirred at 85° C. for 8-ten hours. After cooling to room temperature, 5% aqueous NaOH solution was added (100 mL) and the product extracted with ethyl acetate (400 mL×3). The organic layer was washed thoroughly with water (300 ml×4) followed by brine. After drying over anhydrous MgSO₄, the solvent was evaporated and the product dried using Kugelrohr distillation set up at 35° C. for three hours to give the azide (63 g, 92%).

The starting triol has a Mn of 2600, which brought the H_{d} to 313 J/g, indicating that the heat of decomposition (or in general heat of polymerization) can be lowered by increasing the molecular weight of the azide.

### Example 11

### Synthesis of Resorcinol Propargyl Ether

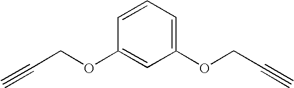

To a solution of resorcinol (30 g, 0.27 mol) in DMF (250 mL) was added K₂CO₃ (83 g, 0.6 mol) and stirred for 30 minutes. To this mixture was added propargyl bromide (61 mL of 80 wt % solution) and the resulting solution was stirred overnight at room temperature Ethyl acetate (600 mL) was added and the precipitate filtered. The filtrate was washed with water (4×300 mL) followed by brine. The organic layer was dried over anhydrous MgSO₄ and the solvent evaporated. The product was dried using Kugelrohr distillation set up for three hours to furnish resorcinol propargyl ether (39 g, 77%).

### Example 12

### Synthesis of Bisphenol A Propargyl Ether

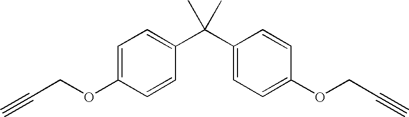

To a solution of bisphenol A (21 g, 91 mmol) in DMF (200 mL) was added K₂CO₃ and the mixture stirred at room temperature for 15 minutes. To this mixture was added propargyl bromide (80 wt % in toluene, 30 mL, 270 mmol) and the mixture stirred at room temperature overnight. TLC indicated the presence of a single spot different from starting material. Ethyl acetate (600 mL) was added and the precipitate filtered. The filtrate was washed with water (4×300 mL) followed by brine. After drying over anhydrous MgSO₄, the solvent was evaporated and the product was dried in Kugelrohr for three hours at 50(C to give bisphenol A propargyl ether (25 g, 91%) as a liquid. This solidified after a month; subsequent batches always gave a solid. Melting point was 93° C.

### Example 13

### Synthesis of 1,1,1-Trishydroxyphenylethane Propargyl Ether

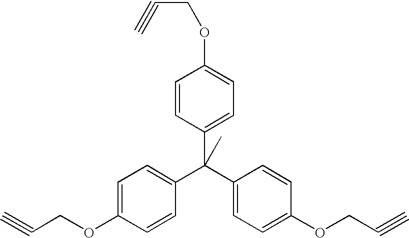

To a solution of 1,1,1-trishydroxyphenyl ethane (20.7 g, 68 mmol) in DMF (200 mL) was added K₂CO₃ and the mixture stirred at room temperature for 30 minutes. To this mixture was added propargyl bromide (80 wt % in toluene, 30 mL, 270 mmol) and the mixture stirred at room temperature overnight. The TLC analysis indicated the presence of two spots (could be dipropargylated and tripropargylated product). The mixture was heated and stirred at 85° C. for four hours, after which the TLC indicated the presence of single spot. After cooling to room temperature, ethyl acetate was added (600 mL) and the mixture was filtered. The filtrate was washed with water (4×300 mL) followed by brine. After drying over anhydrous MgSO4, the solvent was evaporated and the product was dried in Kugelrohr for three hours at 50° C. to give propargyl ether (26 g, 92%) as a low melting solid (melting point was 65° C.).

### Example 14

### Synthesis of Bisphenol E Propargyl Ether

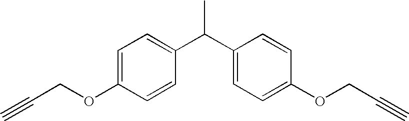

To a solution of bisphenol E (50 g, 93 mmol) in DMF (300 mL) was added K₂CO₃ (97 g, 702 mmol) and stirred for 30 minutes at room temperature To this mixture was added 80 wt % solution of propargyl bromide in toluene (65 mL, 585 mmol) slowly over a period of 30 minutes. The resulting mixture was stirred at room temperature overnight. Ethyl acetate (1000 mL) was added and the mixture filtered. The filtrate was washed with water (4×400 mL) to remove DMF and the organic layer was dried over anhydrous MgSO₄. The solvent was evaporated and the product dried using Kugelrohr distillation set up at 45° C. for three hours to afford product (66 g, 97%).

### Example 15

### Synthesis of N,N,N′,N′-Tetrapropargylphenylene Diamine

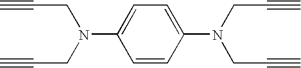

To a DMF (100 mL) solution of p-phenylenediamine (10.5 g, 97 mmol) and K₂CO₃ (53.7 g, 388 mmol) at 0° C. was added propargyl bromide (29 mL, 388 mmol) slowly dropwise over a period of 30 minutes (the reaction is very exothermic). After stirring at room temperature overnight, ethyl acetate was added (400 mL) and the precipitate was filtered off. The filtrate was washed with water (4×200 mL) followed by brine. After drying over anhydrous MgSO₄, the solvent was evaporated and the product dried using Kugelrohr distillation setup to afford the product (13.5 g, 52%).

### Example 16

### Synthesis of N,N,N′,N′-Tetrapropargyl-m-phenylenedioxy-dianiline

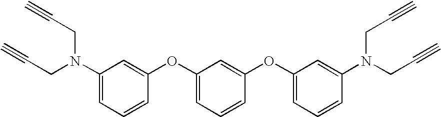

To a mixture of 3,3′-phenylenedioxy dianiline (7.3 g, 25 mmol) and K₂CO₃ (13.8 g, 100 mmol) in DMF (75 mL) at room temperature was added propargyl bromide (7.52 mL, 100 mmol) slowly dropwise over a period of 30 minutes. The resulting mixture was stirred at room temperature overnight. Ethyl acetate (150 mL) was added and the precipitate filtered off. The organic layer was washed several times with water (50 ml×4) followed by brine. After drying over anhydrous MgSO₄, the solvent was evaporated and the product was dried using kugelrohr distillation set up for three hours at 50° C. to give the product (7.1 g, 64%).

### Example 17

### Synthesis of Dimer Acid Propargyl Ester

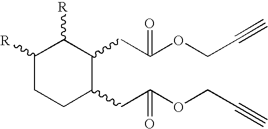

To a solution of dimer acid (34 g, 60 mmol) in CH₂Cl₂ (250 mL) was added thionyl chloride (35.9 g, 302 mmol) at 0° C. A drop of DMF was added. The resulting mixture was stirred at 0° C. for one hour and at room temperature for four hours. CH₂Cl₂ was evaporated using a rotavapor at 50° C. and the residue was dissolved CH₂Cl₂ (150 mL) and triethylamine (34 ml, 237 mmol) was added at 0° C. To this mixture was added propargyl alcohol (12.3 mL, 211 mmol) slowly dropwise over a period of 15 minutes. The resulting mixture was stirred at room temperature overnight. CH₂Cl₂ was evaporated and ethyl acetate (600 mL) was added. The mixture was washed with water (4×200 mL) and brine and dried over anhydrous MgSO4. The solvent was evaporated and the residue was dried using a Kugelrohr distillation setup to afford the product (31 g, 80%).

### Example 18

### Oligomerization of Dimer Azide with Resorcinol Propargyl Ether in Solvent

A mixture of dimer azide (4.5 g, 7.7 mmol) and resorcinol propargyl ether (1.43 g, 7.7 mmol) were heated in toluene (30 mL, 0.25M solution in toluene with respect to azide) at 100° C. for two hours. The solvent was evaporated and the product was dried using Kugelrohr distillation set up for two hours at 45° C. to afford oligomer (quantitative yield). For comparison, two batches of this oligomer were synthesized and submitted for GPC to compare the molecular weight distribution. The molecular weight distribution for the two batches was the same, establishing the reproducibility of the oligomerization method, as disclosed in TABLE 5.

TABLE 5
MOLECULAR WEIGHT DISTRIBUTION
OF OLIGOMER PREPARED IN SOLVENT

| Entries | Mn | Mw | Mw/Mn |
|---|---|---|---|
| Batch 1 | 2036 | 3343 | 1.6 |
| Batch 2 | 1976 | 3201 | 1.6 |

### Example 19

### Oligomerization of Dimer Azide with Resorcinol Propargyl Ether in Bulk

A mixture of 5.024 g dimer azide and 1.587 g resorcinol propargyl ether were blended by hand in a small plastic jar. Cu(I) iodide, 0.132 g, was added to the mixture and the jar placed in a speed mixer for 30 seconds at 3000 rpm. Viscosity of the mixture increased dramatically indicating increase of molecular weight. In less than 20 minutes, the mixture became a solid, which was soluble in methylene chloride, and partially soluble in o-xylene, THF, and toluene. The solid was still soluble in methylene chloride after being aged at room temperature for 24 hours, indicating the solid has thermoplastic characteristics.

A second mixture of 2.018 g dimer azide and 0.6341 g resorcinol propargyl ether were blended in a small plastic jar. Cu(I) iodide, 0.0133 g was added to the mixture and the jar placed in a speed mixer for 30 seconds at 3000 rpm. As with the first batch there was a dramatic increase in molecular weight and in less than 20 minutes, the mixture became solidified.

The mixture was mixed on a Speed Mixer for 30 sec at 3000 rpm.

Viscosity of the mixture increased dramatically indicating increase of molecular weight. In less than 20 minutes, the mixture became a solid. After aging at room temperature for 24 hours, the solid was still soluble in methylene chloride, THF, toluene, o-xylene, chloroform, and N-methylpyrrolidone, indicating thermoplastic characteristics.

GPC data for the two batched showed the molecular weight of the solid was in the oligomer range. The results are set out in TABLE 6.

TABLE 6
MOLECULAR WEIGHT DISTRIBUTION
OF OLIGOMER PREPARED IN BULK

| Sample Name | Mn | Mw | Mz | Polydispersity |
|---|---|---|---|---|
| 13705-26C | 6740 | 31362 | 73024 | 4.65 |
| 13705-26E | 11577 | 57466 | 152405 | 4.97 |

### Example 20

### Oligomerization of Dimer Azide with Bisphenol A Propargyl Ether

A solution of dimer azide (3.7 g, 6.3 mmol) and bisphenol A propargyl ether (1.83 g, 6.3 mmol) in toluene (13 mL, 0.5M solution with respect to the azide) was heated at 100° C. for three hours and 30 minutes. After cooling to room temperature, toluene was evaporated and the residue was dried in Kugelrohr distillation set up for two hours at 45° C. to afford the oligomer (quantitative yield). The ^{1H} NMR spectrum of the oligomer showed the presence of triazole proton. For comparison, two batches of these oligomers were prepared under identical conditions and given to GPC to determine molecular weight distribution. The GPC showed identical molecular weight distributions for the two batches, thus proving the reproducibility of this oligomerization.

### Example 21

### Reaction of Silane/Isocyanate and Propargyl Amine to Form an Alkyne and Silane Adduct (Adhesion Promoter)

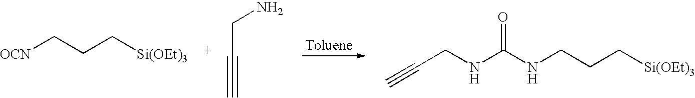

Propargyl amine (5 g, 91 mmol) was dissolved in toluene (100 mL) in a 500 mL three-necked flask equipped with a mechanical stirrer, addition funnel, and nitrogen inlet/outlet. The reaction flask was placed under nitrogen and the solution heated to 50° C. The addition funnel was charged with a compound containing both silane and isocyanate functionality (SILQUEST A-1310 from GE Silicones) (22.2 g, 91 mmol) dissolved in toluene (50 mL). This solution was added slowly dropwise to the amine solution over ten minutes and the resulting mixture was heated for an additional one hour at 50° C. The reaction progress was monitored by observing the disappearance of the isocyanate band at 2100 cm⁻¹ by IR. After cooling the mixture to room temperature, the mixture was washed with distilled water and the organic layer dried over anhydrous MgSO₄, and filtered. The solvent was evaporated using a ROTOVAP vacuum and the product dried further using a Kugelrohr distillation set-up to give the corresponding urea as a brown solid (21 g, 77%). The product melting point was 54° C.

### Example 22

### Reaction of Silane/Isocyanate and Propargyl Alcohol to Form an Alkyne and Silane Adduct (Adhesion Promoter)

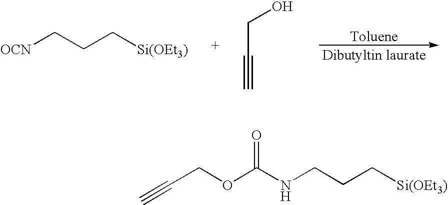

A compound containing both silane and isocyanate functionality (Silquest A-1310, GE Silicones) (21.8 g, 89 mmol) was dissolved in toluene (100 mL) in a 500 mL 3-necked flask equipped with a mechanical stirrer, addition funnel, and nitrogen inlet/outlet. The reaction was placed under nitrogen and 0.02 g of dibutyltin dilaurate was added with stirring as the solution was heated to 80° C. The addition funnel was charged with propargyl alcohol (5 g, 89 mmol) dissolved in toluene (50 mL). This solution was added to the isocyanate solution over ten minutes and the resulting mixture was heated for an additional three hours at 80° C. The progress was monitored by IR by observing the disappearance of isocyanate band at approximately 2100 cm⁻¹. After cooling the mixture to room temperature, the mixture was washed with distilled water and the organic layer dried over anhydrous MgSO₄ and filtered. The solvent was removed in vacuum to give the product as a brown liquid (23 g, 86%). The viscosity was 82 cPs at room temperature.

### Example 23

### Reaction of Propargyl Amine with Polybutadiene Adducted with Maleic Anhydride (Film)

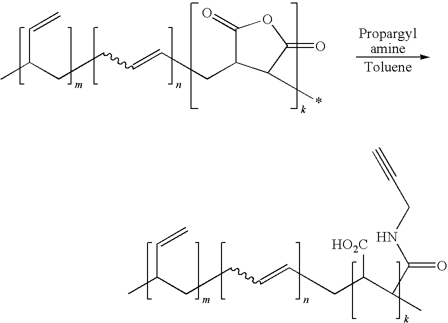

To a toluene (150 mL) solution of polybutadiene adducted with maleic anhydride (RICON MA-13, Ricon Resins, Inc.) (26 g, 34 mmol) at room temperature was added propargylamine (2.44 g, 44 mmol) in one portion and the mixture stirred at room temperature for about three hours. The reaction progress was monitored by IR (after slow toluene evaporation from the sample). The IR spectrum indicated complete consumption of anhydride evidenced by disappearance of characteristic bands at 1860 and 1780 cm⁻¹ and appearance of new bands at 1713 and 1653 cm⁻¹ for the acid and amide functionalities, respectively, of the product. The mixture was stirred for an additional one hour. The solvent was evaporated using a ROTOVAP vacuum and the product dried using a Kugelrohr distillation set-up (bath temperature 50° C.) followed by heating in a vacuum oven under vacuum at 60° C. overnight. The product was a dark brown highly viscous liquid (28.44 g, 84%). The viscosity was too high to be measured.

### Example 24

### Reaction of N-Methylpropargyl Amine with Polybutadiene Adducted with Maleic Anhydride (Film)

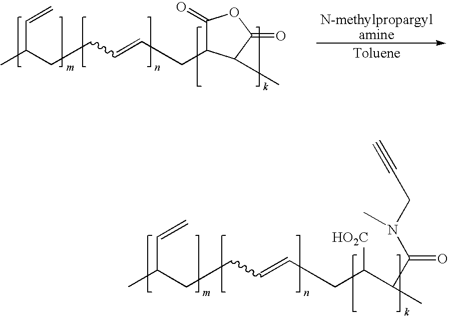

To a toluene (150 mL) solution of polybutadiene adducted with maleic anhydride (RICON MA-13, Ricon Resins, Inc.) (48.8 g, 26 mmol) at room temperature was added N-methylpropargylamine (2 g, 29 mmol) in a single portion and the mixture stirred at room temperature for two hours. The reaction progress was monitored by IR, and the IR spectrum indicated complete consumption of anhydride evidenced by the disappearance of characteristic bands at 1860 and 1780 cm⁻¹ and appearance of new bands at 1713 and 1653 cm⁻¹ for the acid and amide functionalities, respectively of the product. The mixture was stirred for an additional two hours. The solvent was evaporated using a ROTOVAP vacuum under reduced pressure; residual solvent was removed by heating in a vacuum oven at 60° C. overnight to give the N-methylpropargylamide (18 g, 83%). The viscosity at 50° C. was 39,150 cPs.

### Example 25

### Synthesis of Propargyl Ester from Polybutadiene Adducted with Maleic Anhydride

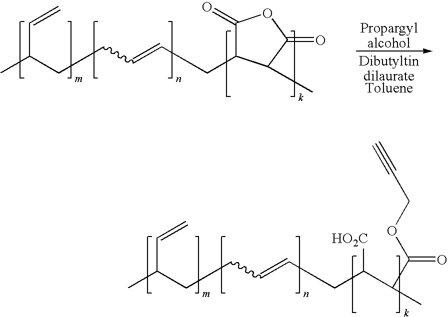

In a three necked 250 mL flask containing a reflux condenser and a nitrogen inlet was charged polybutadiene adducted with maleic anhydride (RICON MA-13, Ricon Resins, Inc.) (25 g, 33 mmol) and propargyl alcohol (3.7 g, 83 mmol) in toluene (150 mL). To this mixture were added four drops of dibutyltin dilaurate and the mixture heated to 80° C. (bath temperature) for about four hours. The reaction progress was monitored by IR. The IR spectrum showed a small amount of residual anhydride (band at 1860 cm⁻¹, feeble compared to the starting material). An additional one mL of propargyl alcohol was added and the reaction heated at 80° C. (bath temperature) for an additional two hours and at room temperature for two days. Toluene was evaporated using a ROTOVAP vacuum under reduced pressure. Further drying was performed using a Kugelrohr distillation set-up (bath temperature 50° C.) followed by heating in a vacuum oven at 60° C. overnight. This gave the product as a brown liquid (22 g, 82%)

### Example 26

### Synthesis of Azide from Polybutadiene Adducted with Maleic Anhydride

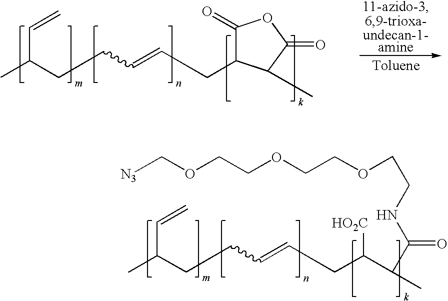

To a toluene (50 mL) solution of polybutadiene adducted with maleic anhydride (RICON MA-13, Ricon Resins, Inc.) (3.6 g, 34 mmol) at room temperature was added 11-azido-3,6,9-trioxaun-decan-1-amine (1.03 g, 44.3 mmol) in one portion and the mixture stirred at room temperature for about four hours. The reaction progress was monitored by IR by observing the disappearance of anhydride peaks in the IR. The IR spectrum indicated complete consumption of anhydride as evidenced by disappearance of characteristic bands at 1860 and 1780 cm⁻¹ and appearance of new bands at 2100, 1713 and 1640 cm⁻¹ for the azide, acid and amide functionalities, respectively, of the product. Toluene was evaporated under reduced pressure using a ROTAVAP vacuum. Further drying was done in a Kugelrohr distillation set-up under vacuum at 55° C. for two hours and by heating in a vacuum oven overnight at 50° C. The product was an amide having pendant azide functionality adducted to a polybutadiene adducted with maleic anhydride (4.6 g, quantitative).

### Example 27

### Grafting of 2-Mercaptoethanol to Polybutadiene

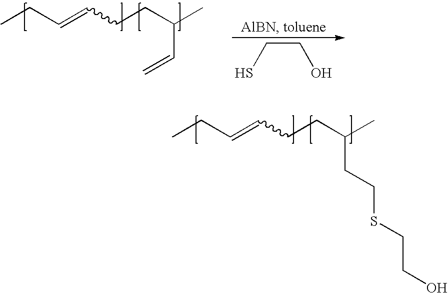

In a 500 mL 3 necked flask equipped with a condenser and nitrogen inlet were introduced polybutadiene (54 g, 620 mmoles, predominantly 1,2 addition), 2-mercaptoethanol (4.4 g, 56 mmoles), and toluene (270 mL). Under stirring, the mixture was saturated with nitrogen for ten minutes. When the mixture temperature reached 85° C. (reaction temperature), AIBN (46 mg, 0.56 mmol) was added to the reaction flask. A second addition of AIBN identical to the first one was done at four hours to maintain constant radical conditions. The reaction was stirred for an additional four hours and the thiol consumption was monitored by IR (disappearance of weak peak at 2500 cm⁻¹). The completion of the reaction was further indicated by the absence of thiol smell in the sample. After about eight hours of total reaction time, toluene was evaporated using a ROTOVAP vacuum (bath temperature 60° C.). The sample was further dried using a Kugelrohr distillation set-up (bath temperature 55° C.) for three hours followed by heating in a vacuum oven overnight at 50° C. This gave the adduct as a colorless viscous liquid (58 g, 99%). The viscosity at 50° C. was 16,130 cPs.

### Example 28

### Grafting of 2-Mercaptoethanol (Higher Percentage) to Polybutadiene

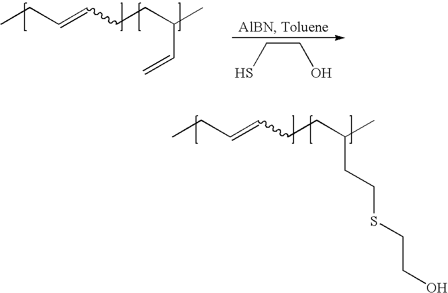

In a 500 mL three-necked flask equipped with a condenser and nitrogen inlet were introduced polybutadiene (54 g, 620 mmol, predominantly 1,2 addition), 2-mercaptoethanol (9.6 g, 123 mmol), and toluene (270 mL). Under stirring, the mixture was saturated with nitrogen for ten minutes. When the mixture temperature reached 85° C. (reaction temperature), AIBN was added to the reaction flask. A second addition of AIBN identical to the first one was done at four hours to maintain constant radical conditions. The thiol consumption was monitored by IR and evidenced by the disappearance of weak peak at 2500 cm⁻¹. The completion of the reaction was further indicated by the absence of thiol smell in the sample. After about eight hours of total reaction time, the reaction was stopped. Toluene was evaporated using a ROTOVAP vacuum (bath temperature 60° C.). The sample was further dried using a Kugelrohr distillation set-up (bath temp 55° C.) for three hours and by heating in a vacuum oven at 50° C. overnight. This gave a colorless highly viscous liquid (58 g, 91%). The viscosity at 50° C. was 53,240 cPs.

### Example 29

### Synthesis of Alkyne Functionalized Polybutadiene

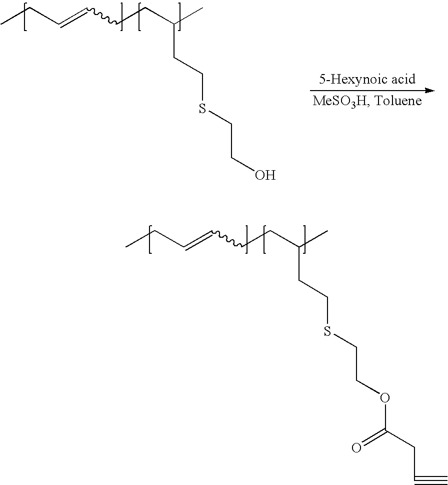

In a 500 mL four-necked flask equipped with a mechanical stirrer and Dean Stark set-up was charged a solution of 2-mercaptoethanol grafted polybutadiene (10.4 g, 10 mmol with room temperature mercaptoethanol) in toluene (100 mL). To this were added 5-hexynoic acid (2.46 g, 21.9 mmol) and methanesulfonic acid (0.67 g, 6.9 mmol). The mixture was heated at 140° C. (oil bath temperature, maximum reaction temperature of 112° C.) for five hours. The reaction progress was monitored by IR. Aliquots were taken and washed with aqueous NaHCO₃ solution and an IR spectrum run on each to determine conversion as evidenced by the disappearance of the OH peak. After about five hours, the reaction mixture was cooled to room temperature and 30 g of resin (AMBERLYST A-21 resin, wet) were added and stirred for one hour. The mixture was filtered and washed with ethyl acetate. Silica gel (25 g) was added to the filtrate and stirred for one hour. After filtering, the solvent was evaporated under reduced pressure using a ROTOVAP vacuum (water bath temperature 60° C.). Further drying was performed using a Kugelrohr distillation set-up under vacuum at an oven temperature 75° C. for five hours followed by heating in a vacuum oven overnight at 50° C. This gave a viscous dark brown liquid (11.4 g, 90%). The viscosity at 50° C. was 30,550 cPs.

### Example 30

### Synthesis of Alkyne Functionalized Butyl Acrylate-Styrene Copolymer

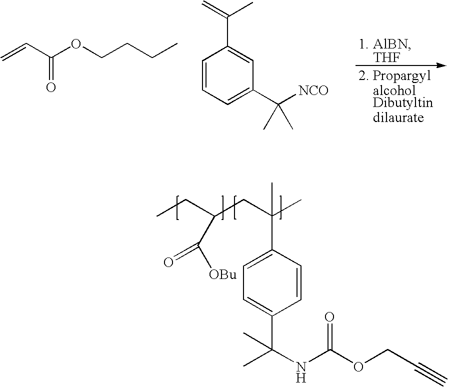

To a solution of butyl acrylate (50 g, 390 mmol) and m-TMI (7.84 g, 39 mmol, 10:1 molar ratio of butyl acrylate:isopropenyl dimethyl benzyl isocyanate (hereinafter m-TMI) (Cytec) in dry tetrahydrofuran (hereinafter THF) (173 mL) in a three necked flask equipped with a mechanical stirrer, reflux condenser and nitrogen inlet, was added azoisobutyronitrile (hereinafter AIBN) (578 mg, 1 wt % at room temperature to the total monomer content). After overnight heating at 65° C. (reaction temperature), an additional 0.17 wt % of AIBN was added to ensure completion of polymerization, after which the reaction temperature was raised to 80° C. and the reaction contents stirred for three hours. After the polymerization was determined to be complete, 100 mg of methylhydroquinone (hereinafter MeHQ) were added and the mixture heated for one hour 30 minutes at 80° C. to decompose all the initiator and to prevent potential alkyne polymerization after the propargyl alcohol addition. After cooling to room temperature propargyl alcohol (2.6 g, 46 mmol) and dibutyltin dilaurate (four drops) were added and the reaction was heated at 80° C. for about six hours. After completion of the reaction as evidenced disappearance of isocyanate group by IR, the mixture was concentrated under vacuum using a ROTOVAP vacuum and the viscous mixture poured into heptane (400 mL) (1:7 ratio of monomer and solvent) and stirred for one hour. The solvent mixture was decanted and an additional 100 mL of heptane were added to the precipitate and stirred for 30 minutes, after which the heptane was decanted to remove all the dissolved residual monomer from the sticky polymer. The sticky polymer was then transferred with ethyl acetate to a 500 mL flask and the solvent evaporated using a ROTOVAP vacuum at 60° C. Further drying was done using a Kugelrohr distillation set-up for two hours at 55° C. and heating in a vacuum oven overnight at 50° C. This gave a very sticky dark brown polymer (38 g, 63%). The viscosity could not be measured for this polymer even at 50° C.

### Example 31

### Alkyne Functionalization of Acrylic Polyol

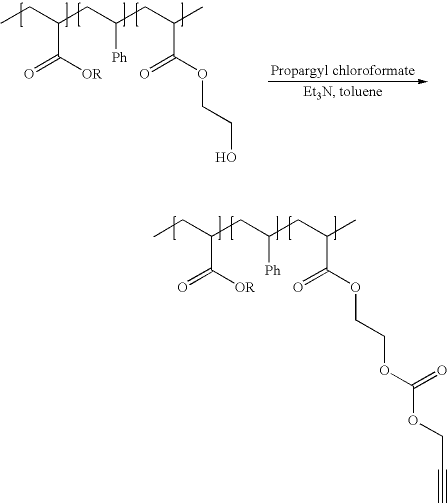

Acrylic polyol (100% solids, JONCRYL 587 polymer from S.C. Johnson) (eq.wt./hydroxyl group=600, 50 g, 83 mmol) was solvated with toluene (200 mL) by stirring for one hour at room temperature. To this solution at 0° C. were added triethylamine (12.65 g, 125 mmol) followed by propargyl chloroformate (14.8 g, 125 mmol, slow addition over 5 minutes). The mixture was stirred at room temperature for approximately 20 hours, and then diluted with ethyl acetate (400 mL) and washed with water three times (200 mL each). After drying over anhydrous MgSO₄, the solvent was evaporated using a ROTOVAP vacuum and the product dried in a vacuum oven overnight under vacuum at 60° C. to give a white solid (57 g, 95%). The NMR and IR of the product were consistent with the structure. However, the GPC showed some crosslinking likely arising from trans-esterification of the hydroxyl group with the ester group of another polymer under basic conditions.

### Example 32

### Synthesis of Propargyl Functionalized Maleimide

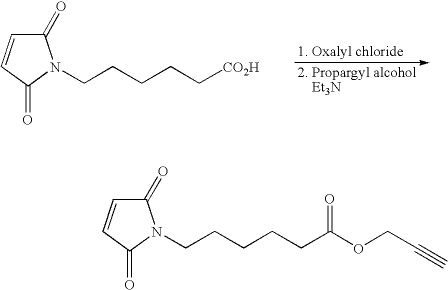

In a 500 mL 3 necked flask with a nitrogen inlet was charged a solution of MCA (25 g, 118 mmol) in CH₂Cl₂ (200 mL). To this mixture at 0° C. was added oxalyl chloride (15 g, 118 mmol) and a drop of DMF. The mixture was stirred at room temperature for two hours. After cooling to 0° C., propargyl alcohol (7.3 g, 130 mmol) and triethylamine (14.4 g, 142 mmol) were added and the resultant mixture stirred at room temperature for approximately 14 hours). CH₂Cl₂ was evaporated and the residue was dissolved in ethyl acetate (300 mL) and washed with aqueous NaHCO₃ solution (100 mL), followed by several washes with water. The organic layer was dried over anhydrous MgSO₄ and filtered. Silica gel (60 g) was added to the filtrate, and the mixture then stirred for two hours, filtered to remove the silica gel, and washed with ethyl acetate (60 mL). The solvent was removed under reduced pressure using a ROTOVAP vacuum and the product was dried using a Kugelrohr distillation set-up at 50° C. for two hours. This gave a brown less viscous liquid, which solidified upon storage under refrigeration (14 g, 47%, m.p. was 36° C.).

### Example 33

### Azide-Alkyne Chemistry Containing Maleimide Functionality

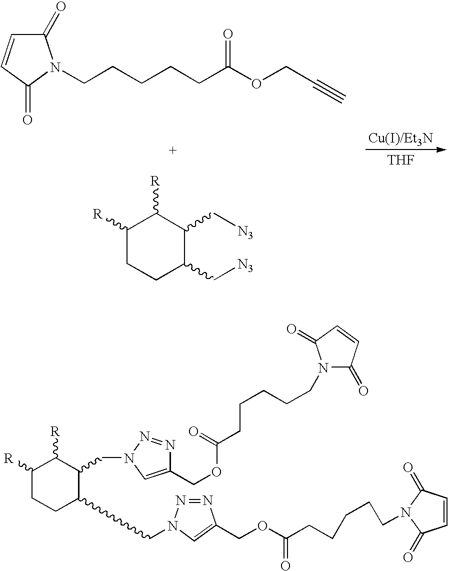

In a three-necked 250 mL flask with a nitrogen inlet were added dimer azide (4.3 g, 7.3 mmol), propargyl ester of maleimide (3.74 g, 15 mmol) and dry THF (150 mL) under nitrogen atmosphere. To this mixture were added triethylamine (1.49 g, 14.7 mmol) and CuI (140 mg, 0.7 mmol). The resultant mixture was stirred at room temperature under nitrogen for 24 hours. The conversion was monitored by IR (disappearance of azide absorbance at 2100 cm⁻¹). After about 24 hours, ethyl acetate (300 mL) was added and the mixture washed several times with water. The organic layer was dried over anhydrous MgSO₄ and the solvent was evaporated under reduced pressure using a ROTAVAP vacuum. Further drying was done using a Kugelrohr distillation set-up at 50° C. for two hours. This gave a viscous brown liquid (7 g, 87%). The viscosity at 50° C. was 9420 cPs.

### Example 34

### Synthesis of Bistriazole-Dimethanol

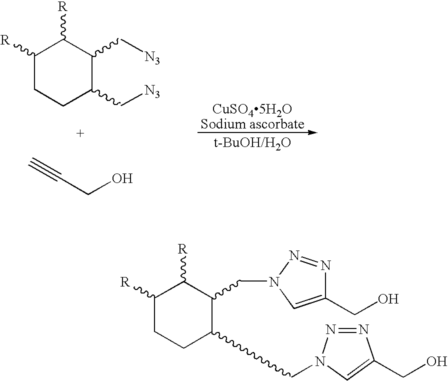

In a 250 mL three necked flask with nitrogen inlet was charged a 2:1 mixture of tBuOH and water (50 mL and 25 mL respectively). To this mixture under nitrogen were added dimer azide (5 g, 8.5 mmol), propargyl alcohol (5 g, 89 mmol) and CuSO₄.5H₂O (150 mg, 0.6 mmol) and sodium ascorbate (300 mg, 1.5 mmol). The resulting mixture was stirred for 24 hours under nitrogen. The progress of the reaction was monitored by IR as evidenced by the disappearance of the azide peak at 2100 cm⁻¹. The IR samples were added to ethyl acetate and washed with water. At reaction completion, ethyl acetate (250 mL) was added and the mixture was washed with water, brine, and then dried over anhydrous MgSO₄. After solvent evaporation in a ROTOVAP vacuum under vacuum, the product was dried using a Kugelrohr distillation set-up for four hours at 60° C. followed by heating in a vacuum oven overnight at 50° C. This gave a brown viscous liquid (4.9 g, 82%).

### Example 35

### Synthesis of Triazole Linked BMI by Fischer Esterification

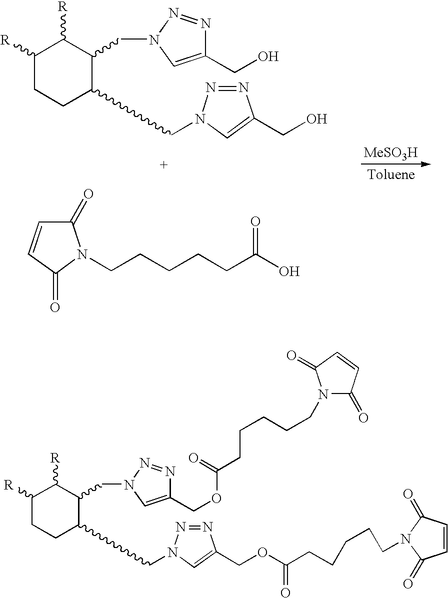

In a 500 mL four-necked flask equipped with a mechanical stirrer and Dean-Stark set-up, was charged a solution of bistriazole-dimethanol (5 g, 7.1 mmol) in toluene (100 mL). Maleimidocaproic acid (3.8 g, 17.9 mmol) was added followed by methanesulfonic acid (0.24 g, 2.4 mmol), and the mixture then heated to 140° C. (oil bath temperature, maximum reaction temperature=112° C.) for six hours. The reaction progress was monitored by IR by observing the disappearance of hydroxyl peak at 3400 cm-1. IR samples were prepared by washing with water to remove acid. After about six hours of reaction time, the mixture was cooled to room temperature. A resin (wet Amberlyst A-21) (20 g) was added and stirred for one hour. After filtering, silica gel was added (20 g) to the filtrate and stirred for another hour, then filtered to remove the silica gel. The solvent was evaporated using a ROTOVAP vacuum under reduced pressure at 55° C. Further drying was performed using a Kugelrohr distillation set-up at 60° C. for three hours followed by heating in the vacuum oven overnight at 50° C. This gave a light brown very viscous liquid (6.6 g, 85%). The viscosity at 50° C. was 9420 cPs.

### Example 36

### Azide-Alkyne Chemistry Containing Methacrylate Functionality Synthesis of Triazole Linked Dimethacrylates by Acid Chloride Reaction

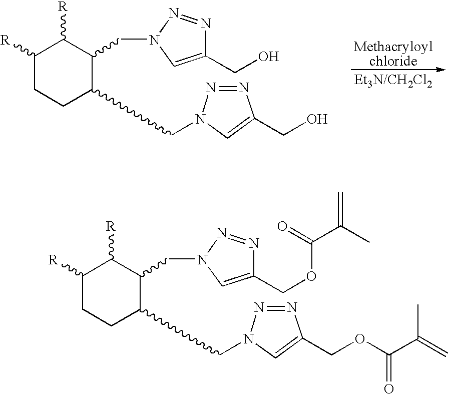

In a three-necked 250 mL flask with a nitrogen inlet were added bistriazole-dimethanol (5 g, 7.1 mmol) and CH₂Cl₂ (100 mL). To this mixture were added methacryloyl chloride (2.25 g, 21.5 mmol) and triethylamine (2.54 mL, 25 mmol) at 0° C. The resultant mixture was stirred at room temperature overnight. The progress of the reaction was monitored by disappearance of OH peak in the IR spectrum. After the completion of the reaction (about 14 hours), ethyl acetate (300 mL) was added to the mixture and washed with aqueous NaHCO₃ solution and water. The organic layer was dried over anhydrous MgSO₄, 10 mg of MeHQ was added and the solvent was evaporated under reduced pressure using a ROTOVAP vacuum. The residual solvent was evaporated using a Kugelrohr distillation set-up at 50° C. for four hours. This gave the dimethacrylate as a yellow viscous liquid (4.8 g, 80%).

### Example 37

### Azide/Alkyne Chemistry with Thermoset or Thermoplastic Polymers

A combination of azide/alkyne polymerization and radical or cationic polymerization to form a thermoset or thermoplastic polymer was performed on various resins and initiator systems. These polymerizations, the azide/alkyne and the radical or cationic polymerizations, can occur simultaneously or sequentially, depending on the nature of the catalyst and whether one or more than one catalyst is used. The Cu(I) catalyst or in situ generated Cu(I) catalyst can initiate both the azide/alkyne chemistry and the radical polymerization of the thermoset or thermoplastic polymer, but optionally, a radical curing agent may also be added to the polymerization mix. If a single initiating species is used, both polymerizations will occur at the same time. If a radical initiator is used in addition to the copper catalyst, and the temperature at which the radical catalyst is activated is different from the temperature at which the copper catalyst is activated, the polymerizations will occur sequentially. The polymerizations were confirmed by DSC.

In the following formulations, the dialkyne, diacrylate, maleimide and dioxetane (DOX) used have the structures

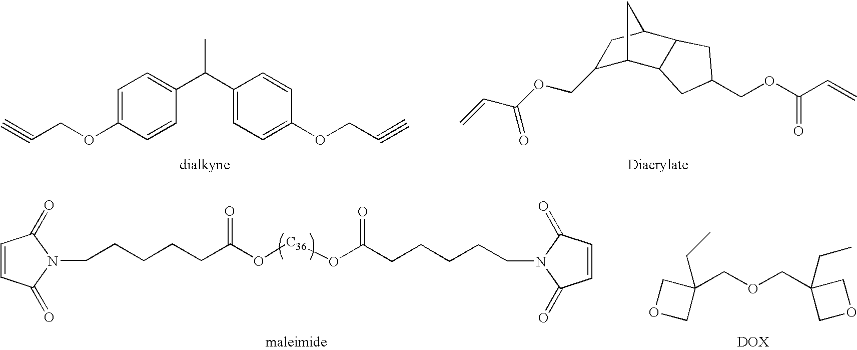

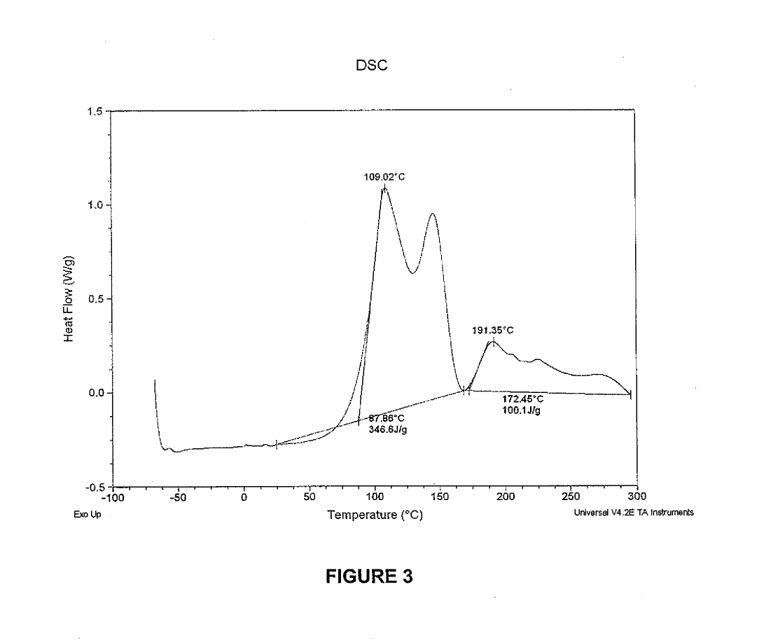

Formulation 37a was prepared by mixing the following: dimer azide 1 g, dialkyne 0.49 g, diacrylate 1 g, peroxide initiator 20 mg, and CuSBu 15 mg. This formulation included two different catalysts, the peroxide initiator for the radical polymerization of the diacrylate and the copper catalyst for the azide/alkyne polymerization. This system showed a very broad cure profile that indicated sequential polymerization of azide/alkyne resins and radical polymerization of acrylate resin taking place independently of each other, as indicated in the DSC cure profile in FIG. 3.

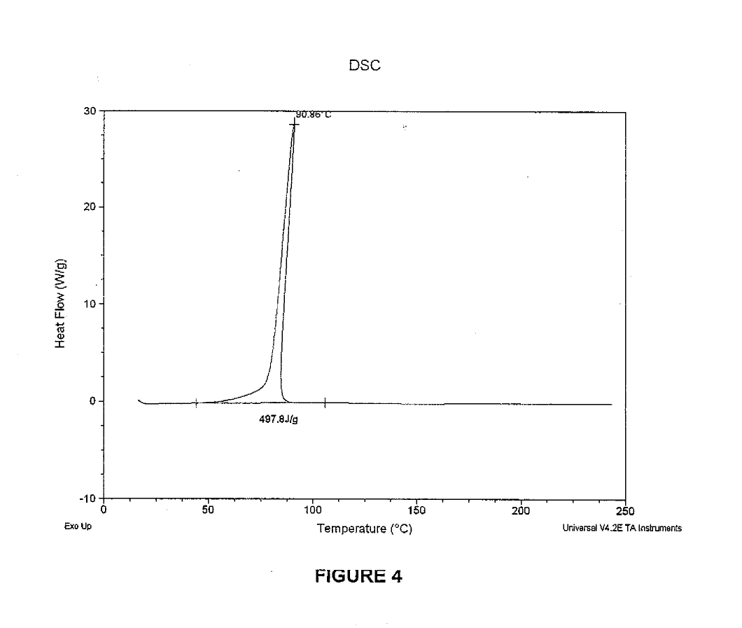

Formulation 37b was prepared by mixing the following: dimer azide 1 g, dialkyne (0.49 g), Cu(II)napthenate 20 mg, cumene hydroperoxide 29 mg, benzoin 20 mg, diacrylate 1 g. This formulation used the Cu(I) catalyst for the azide/alkyne polymerization, which Cu(I) catalyst arises from the in situ reduction of the Cu(II) naphthenate to the Cu(I) species by the benzoin. The same Cu(I) catalyst initiated redox radical polymerization of the acrylate in combination with the cumene hydroperoxide. This formulation showed a single exotherm in the DSC indicating that both azide/alkyne polymerization chemistry and redox radical chemistry are taking place simultaneously, initiated by Cu(I) species generated in situ. The DSC curve is shown in FIG. 4.

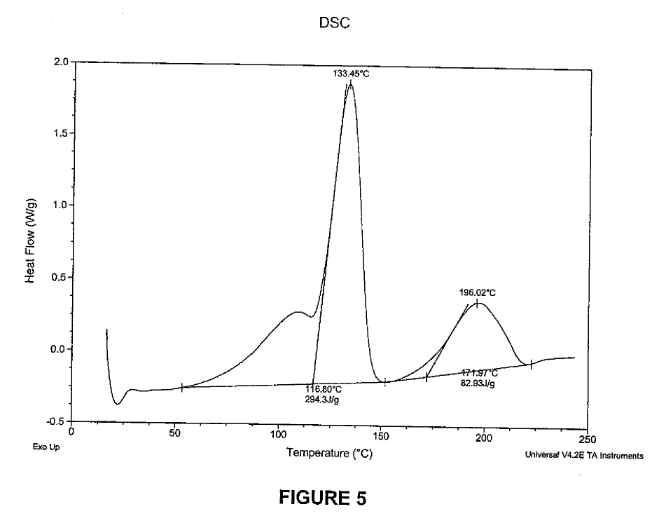

Formulation 37c was prepared by mixing the following: dimer azide 1 g, dialkyne 0.49 g, maleimide 1 g, CuSBu 20 mg, cumene hydroperoxide (20 mg). In this formulation, the CuSBu species initiated both the azide/alkyne polymerization and the redox radical polymerization of the maleimide in combination with cumene hydroperoxide. The DSC cure profile for this system is shown in FIG. 5.

Formulation 37d was prepared by mixing the following: dimer azide 1 g, dialkyne 0.49 g, Bifunctional oxetane (2 g, DOX from Toagosei Co.), iodonium salt (RHODORSIL 2074, Gelest) 20 mg, Cu(II)naphthenate 20 mg, benzoin 20 mg.

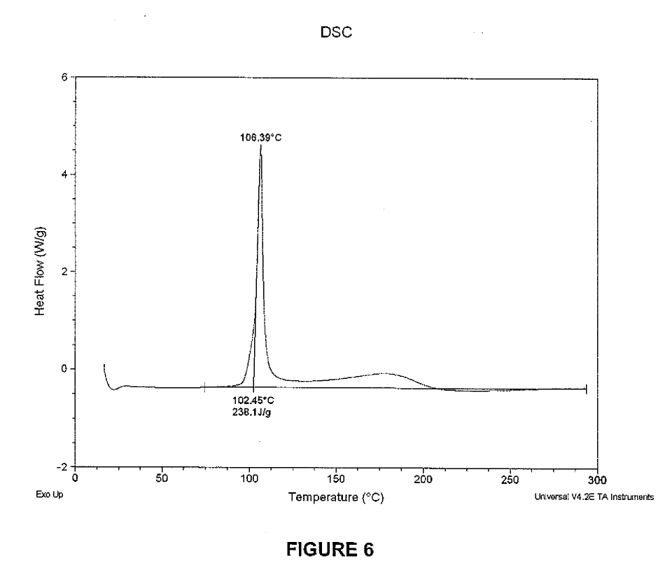

In this formulation the azide/alkyne polymerization and the cationic polymerization of heterocyclic monomers were initiated by a single initiating Cu(I) species, which was generated in situ by the reduction of Cu(II) naphthenate by benzoin. The Cu(I) species with the iodonium salt initiated redox induced cationic polymerization of the oxetanes. This formulation showed a single curing peak in the DSC indicating that both azide/alkyne polymerization and cationic polymerization were initiated simultaneously by a single Cu(I) initiating species as shown in FIG. 6.

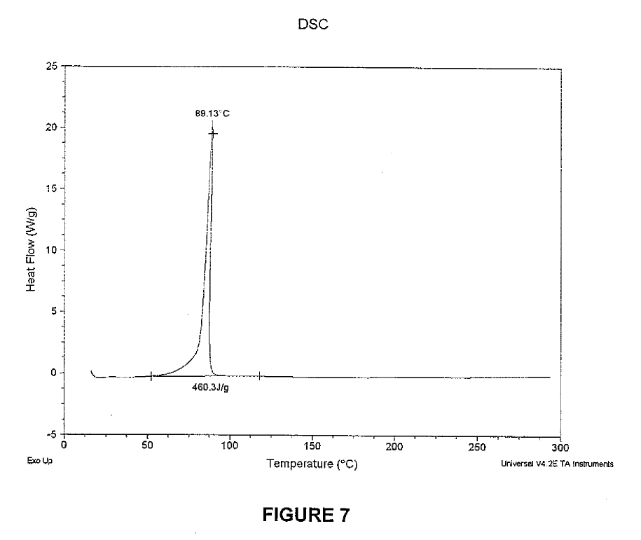

Formulation 37e was prepared by mixing the following: dimer azide 1 g, dialkyne 0.49 g, Cu(II) naphthenate 30 mg, benzoin 21 mg. In this formulation, the combination of Cu(II) naphthenate and benzoin was used to in situ generate the Cu(I) catalyst for the azide/alkyne polymerization. The formulation gave a very sharp DSC curing profile as shown in FIG. 7.

Viscosity measurements in all the examples were made using Brookfield viscometer Model DV-II, with a CP=51 spindle, and, unless otherwise specified, were made at 25° C.

This chemistry may be used for adhesives, encapsulants, and coatings, in any industrial field. It is of particular use for electronic, electrical, opto-electronic, and photo-electronic applications. Such applications include die attach adhesives, underfill encapsulants, antennae for RFID, via holes, film adhesives, conductive inks, circuit board fabrication, other laminate end uses, and other uses within printable electronics.

What is claimed:

1. A process for the synthesis of a product having a triazole functionality comprising the bulk polymerization of a first reactant having an azide functionality and a second reactant having a terminal alkyne functionality, using a copper (I) catalyst, or a copper (II) catalyst without a reducing agent, in the absence of any solvent.

2. A product prepared by the process of claim 1.

3. A process for the synthesis of a product having a triazole functionality comprising
(a) reacting a first reactant having an azide functionality and a second reactant having a terminal alkyne functionality, using a copper (I) catalyst, or a copper (II) catalyst without a reducing agent, in the absence of any solvent to form an oligomer,
(b) reacting the oligomer with a reactant having an azide functionality or a reactant having a terminal alkyne functionality, or both, using a copper (I) catalyst, or a copper (II) catalyst without a reducing agent, in the absence of any solvent.

4. A product prepared by the process of claim 3.

5. The process according to claim 1 in which the bulk polymerization of a first reactant having an azide functionality and a second reactant having a terminal alkyne functionality, using a copper (I) catalyst, or a copper (II) catalyst without a reducing agent, in the absence of any solvent occurs in the presence of metal.

6. The process according to claim 5 in which the metal is silver.

7. A product prepared by the process of claim 5.

8. The process according to claim 1 in which the bulk polymerization of a first reactant having an azide functionality and a second reactant having a terminal alkyne functionality using a copper (I) catalyst, or a copper (II) catalyst without a reducing agent, in the absence of any solvent occurs in the presence of at least one other polymerizeable reactant.

9. The process according to claim 8 in which the at least one other polymerizable reactant is an epoxy, an oxetane, a maleimide, an acrylate, or any mixture of those.

10. A product prepared by the process of claim 8.

11. A process for the synthesis of a product having a triazole functionality comprising the bulk polymerization of a first reactant having an azide functionality and a second reactant having a terminal alkyne functionality, and the metal salt of an organic acid or the metal salt of a maleimide acid as the catalyst, in the absence of any solvent.

12. A product prepared by the process of claim 11.

13. A process for the synthesis of a product having a triazole functionality comprising the bulk polymerization of a first reactant having an azide functionality and a second reactant having a terminal alkyne functionality, and a copper (I) catalyst, or a copper (II) catalyst without a reducing agent, in the absence of any solvent, in which either the first reactant or the second reactant, or both, further contain a silane functionality.

14. A product prepared by the process of claim 13.

15. A two part adhesive composition in which the first part is a reactant containing an azide functionality and the second part is a reactant containing an alkyne functionality, in which either the first part or the second part, or both, contain a Cu(I) or Cu(II) catalyst.

16. A film adhesive prepared from a polymer containing reactive functionality and from monomers containing azide functionality and alkyne functionality.
